(19) United States
(12) Patent Application Publication
(10) Pub. No.: US 2003/0236796 A1
(43) Pub. Date: Dec. 25, 2003

(54) Method and system for online analytical processing for educational and other outcomes

(76) Inventors: Clark Easter, Monkton, MD (US); Michael Jin, Cockeysville, MD (US)

Correspondence Address: Supervisor, Patent Prosecution Services, PIPER RUDNICK LLP, 1200 Nineteenth Street, N. W., Washington, DC, 20036-2412, US

(21) Appl. No.: 10/406,246

(22) Filed: Apr. 4, 2003

Related U.S. Application Data
(60) Provisional application No. 60/369,557, filed on Apr. 4, 2002.
(60) Provisional application No. 60/385,877, filed on Jun. 6, 2002.
(60) Provisional application No. 60/422,869, filed on Nov. 1, 2002.

(51) Int. Cl. A47B 41/00; G09B 1/00; G06F 17/00; G06F 17/30; G06F 7/00

(52) U.S. Cl. 707/104.1; 707/3; 434/433

(57) ABSTRACT

A computerized method and system for analyzing data relating to a mandated program or an individualized instructional program. The method includes receiving a query, accessing a repository of data relating to the mandated program; and identifying data responsive to the query. The system includes: a network; a terminal coupled to the network; and a server coupled to the network that comprises a program that receives a query, accesses a repository of data relating to the mandated program; and identifies data responsive to the query. The data includes special education-related data such as tenth suspension and related meeting data, annual meeting status data, reevaluation meeting status data, referral processing status data, gap analysis data, individual education plan implementation delay data, drop out and other exit reason data, individual education plan assessment completion status data, and least restrictive environment data.

This application claims priority from U.S. Provisional Application Serial No. 60/369,557, filed Apr. 4, 2002; U.S. Provisional Application Serial No. 60/385,877, filed Jun. 6, 2002; and U.S. Provisional Application Serial No. 60/422,869, filed Nov. 1, 2002. The entirety of each of these provisional applications are incorporated herein by reference.

### BACKGROUND OF THE INVENTION

1. Field of the Invention

The present invention relates to a method and system for analyzing data relating to a mandated individualized instructional program, and in particular to a method and system for analyzing special education data across selected areas of interest.

2. Background of the Technology

Special education is often a bureaucratic quagmire of paperwork, re-work, and ever-changing reporting requirements run rampant for levels kindergarten through 12^{th} grade in public schools. For example, under the Individuals with Disabilities Education Act (IDEA), students are entitled to a free appropriate public education. The IDEA has many specific requirements, including, for example: an evaluation of the child if the parents believe the child needs special education or related services; notification whenever a school wishes to evaluate the child, change the child's educational placement, or refuses a request for an evaluation or a change in placement; and a reevaluation of the child at least once every three years, with a review of the child's educational program at least once during each calendar year. Completion of these multiple requirements for thousands of children simultaneously, each with their own set of timelines, is very difficult to administer and track. School districts are often vulnerable because of incomplete, unavailable, inconsistent, or inaccurate records.

There remains an unmet need for methods and systems to assist with tracking and compliance of such requirements.

### SUMMARY OF THE INVENTION

The present invention solves these problems, as well as others, by providing a special education tracking system (SETS) that utilizes on-line analytical processing (OLAP), providing a system and method for analyzing data relating to a mandated program. In one embodiment, the mandated program includes education requirements, and tracks, analyzes, and manages outcomes for selected interrelated areas or fields, which are referred to as “cubes,” in a user-friendly environment. In one exemplary application, the present invention allows a user to track special education data in order to determine timeline and outcome compliance levels under IDEA and other special education standards. Those skilled in the art will understand that multiple other embodiments are possible, including systems and methods for any other model that contains a workflow model/process measuring work accountability (e.g., doing certain tasks at certain times). Some examples include, but are not limited to, juvenile services, parole requirements, child welfare, and the analyzing of data related to other mandated programs. For example, legal and other requirements and data can be analyzed for any other sub population of school children who require individualized workflow type programs, such as English as a second language, discrimination prevention programs (e.g., “504” programs), “at risk” programs, or specialized discipline programs in schools or other environments, such as prisons.

In one embodiment, the present invention includes a computerized method and system for analyzing data relating to a mandated program. The method includes receiving a query; accessing a repository of data relating to the mandated program; and identifying data responsive to the query. In one embodiment, the system includes: a network; a terminal coupled to the network; and a server coupled to the network, in which the server receives a query, accesses a repository of data relating to the mandated program; and identifies data responsive to the query.

In one embodiment, the data is special education-related, and includes, for example: suspension and related meeting data; annual meeting status data; reevaluation meeting status data; referral processing status data; gap analysis data; individual education plan (IEP) implementation data; drop out and other exit reason data; individual education plan assessment completion status data; and least restrictive environment (LRE) data. In addition, the linking of a specific program of intervention, specific provider of intervention, or specific certification of the provider with instructional information (e.g., attendance data, drop-out data, post secondary job data, state functional test score data, disciplinary are behavior and success with IEP objectives) can be accessed in one embodiment of the present invention. Those skilled in the art will understand that the present invention is not limited to this data, and that other education-related and non education-related data can also be incorporated.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

FIGS. 1A-1C illustrate the primary components of a representative operating environment and a general method overview, according to an embodiment of the present invention.

FIGS. 2A-2D are flowcharts describing the tenth suspension and related meetings cube, according to one embodiment of the present invention.

FIG. 3 is a flowchart describing the annual meetings status cube, according to one embodiment of the present invention.

FIG. 4 is a flowchart describing the reevaluation meetings status cube, according to one embodiment of the present invention.

FIG. 5 is a flowchart describing the referral processing status cube, according to one embodiment of the present invention.

FIG. 6 is a flowchart describing the service gap analysis cube, according to one embodiment of the present invention.

FIG. 7 is a flowchart describing the individual education plan implementation delays cube, according to one embodiment of the present invention.

FIG. 8 is a flowchart describing the drop out and other exit reasons cube, according to one embodiment of the present invention.

FIG. 9 is a flowchart describing the assessment completion status cube, according to one embodiment of the present invention.

FIG. 10 is a flowchart describing the least restrictive environment cube, according to one embodiment of the present invention.

FIGS. 11 through 52 are screen shots illustrating a typical scenario experienced by a user, according to one embodiment of the present invention.

### BRIEF DESCRIPTION OF THE INVENTION

Overview

In one embodiment, the present invention provides a system and method for analyzing data related to the mandated timelines and outcomes of a particular aspect of an individualized instructional program, and displaying the analyzed data in “cubes,” in a user-friendly environment. In an embodiment, the present invention includes a special education tracking system (SETS) utilizing on-line analytical processing (OLAP) that allows a user to track special education data in order to determine performance and compliance levels under the IDEA. An embodiment of the present invention collects, tags, and tabulates information provided from other systems, which is used for analysis using a variety of analytical methods that allow the data to be, for example, collated, combined, and cross-combined across a wide range of categories applicable to the data, using visual and other tools, such as pie charts, graphs, tables, and other comparison methods.

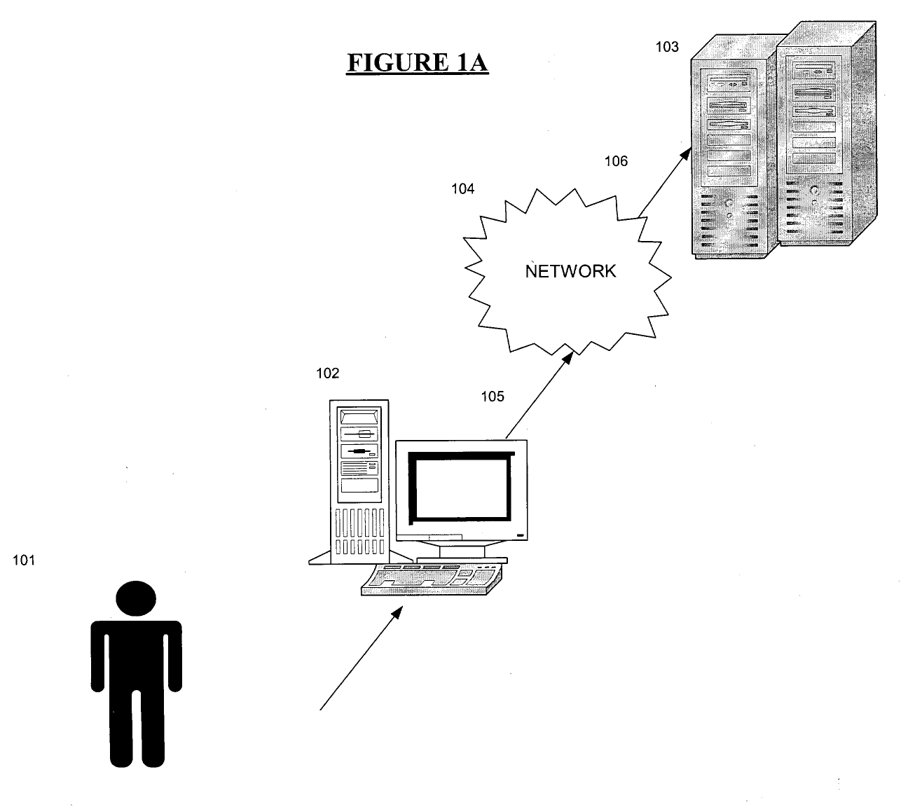

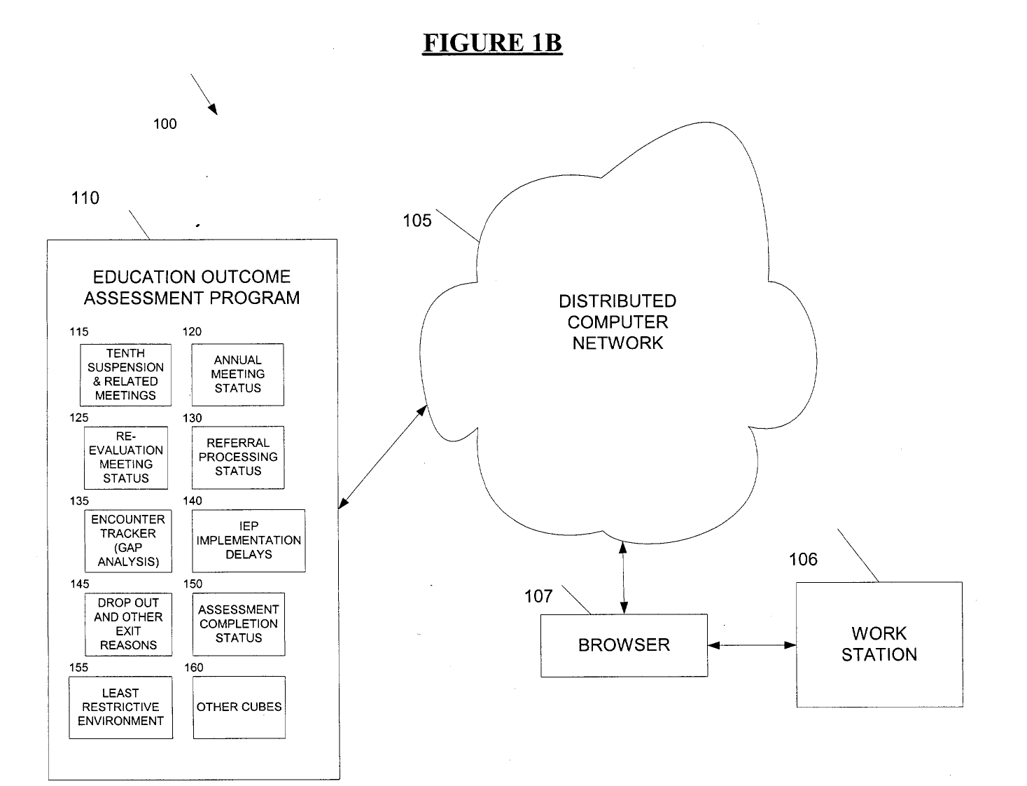

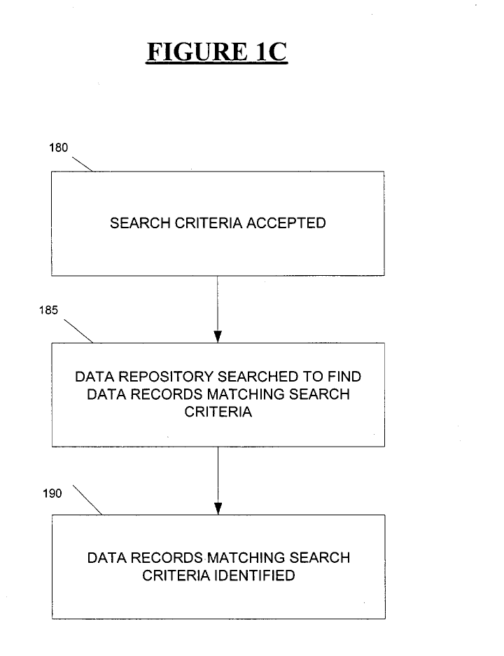

FIG. 1A illustrates an overview pictogram of system elements in accordance with an embodiment of the present invention. The system of the invention provides one or more users 101 with an effective and efficient way of obtaining specialized business solutions via a network 104, such as the Internet or an intranet. The system includes a terminal 102 and a server 103 that are operationally connected to each other through couplings 105, 106, and the network 104 (e.g., the Internet). Terminal 102 includes a user interface to capture information on the client, client business, client market, and client's functional requirements; a memory, operationally coupled to the user interface, to store the captured client's information and functional requirements; and a processor, operationally coupled to a user interface and memory, to create a business strategy and specialized business solutions for the client based on the client's information and functional requirements. The server 103, which includes a processor and memory, delivers the business strategy and specialized business solutions to the client via network 104.

FIG. 1B illustrates additional components of a representative operating environment, according to one embodiment of the present invention. An on-line environment 100 comprises: a distributed computer network 105; at least one workstation 106; at least one browser 107; and an education outcome assessment program 110.

A distributed computer network 105 is a network, such as the global Internet, that facilitates communication between one or more terminals 106, also referred to interchangeably here in as “workstations”, such as personal computers (PCs), minicomputers, microcomputers, main frame computers, telephone devices, or other wired or wireless devices, such as hand-held devices, one or more browsers 107 (e.g., comprising software operating on or via the terminals 106) and an education outcome assessment program 110, which is housed, for example, on a server, (or, for example on one server and terminals 106) which includes, for example, a minicomputer, a microcomputer, a PC, a mainframe computer, or other device with a processor and repository (e.g., database) or coupling to a repository.

One or more workstations 106 accept input from users, and allow users to view output from the education outcome assessment program 110.

In one embodiment, one or more browsers 107 include software on the workstation 106 that allow a user view, for example, HyperText Markup Language (HTML) documents and access files and software related to those documents. The present invention utilizes, for example, HTML-based systems, Java-based systems, eXtensible Markup Language (XML)-based systems and systems where a custom-built application communicates over the network.

The education outcome assessment program 110 is an application that works on or with a browser and/or server to display information to the user. In one embodiment, the education outcome assessment program includes the following cubes: a tenth suspension and related meetings cube; an annual meeting status cube 115; a reevaluation meeting status cube; a referral processing status cube; an encounter tracker (service gap analysis) cube; an IEP implementation delays cube; a drop out and other exit reasons cube; an assessment completion status cube; and an LRE (Least Restrictive Environment) cube. Other education-related cubes may be included in order to facilitate understanding and managing educational data.

The above cubes are tailored to track and report on certain specific special education requirements. These requirements, of course, may change with time and current laws, and the present invention is not limited to these specific requirements. The requirements listed below provide the framework for one embodiment of the present invention. General information on each cube's requirements include the following.

Suspension and related meetings. Under the IDEA, states must make a free appropriate public education (FAPE) available to children with disabilities. Schools cannot suspend children for more than 10 consecutive days or 10 cumulative days in a school year, without first determining if their behavior is related to their disability. If their behavior is a “manifestation” of their disability, further suspension is prohibited. Among the steps required are: conducting a manifestation meeting, completing a functional behavioral assessment (FBA), and developing a behavior intervention plan (BIP). The manifestation meeting is held to determine if the behavior is a “manifestation” of the child's disability. The FBA should help district staff understand the behavioral patterns involved, as well as identify potential behavioral modifications that if implemented, would have a probability of changing or alleviating the child behavior. The BIP should prescribe the actual implementation and timelines for the proposed behavioral interventions identified in the FBA. The manifestation meeting, FBA, and BIP must take place before the 11th day of suspension for a special education child.

Annual meetings. States are required to hold annual meetings for a child at least once a year to review and update the child's IEP (Individualized Educational Plan), as appropriate, in order to ensure maximum educational progress for the child. Trigger events include previous annual meetings or the development of the initial IEP.

Reevaluation meetings. States are required to hold reevaluation meetings for a child at least every three years, to review-assessment data to determine if the child is still eligible for special education, or to determine if there is a change in the disability pattern. Trigger events include a previous reevaluation meeting or the initial eligibility meeting. Evaluations and reevaluations must be comprehensive and must include all relevant tests, given the suspected disability, and could include cognitive, behavioral, social, emotional, physical, and developmental assessments, as well as the child's performance in the general curriculum, as a basis for accurately assessing the disability pattern, which in turn is the foundation for developing the appropriate IEP for the child.

Referral processing. The child find provisions of IDEA require states to locate, identify, and evaluate children with suspected disabilities within a relatively short timeframe. The assessment data is then analyzed by a team, and a determination is made as to whether one or more disabilities exist. If a disability exists, then an appropriate IEP must be developed and implemented for the child with minimal delay. Once a child has had a referral event, the testing, the eligibility meeting and IEP implementation, if appropriate, must all take place within 45 to 70 days (depending upon the particular state) of the referral.

Service Gap analysis. States and school districts must ensure that a student receives provider services detailed in the IEP. Under-servicing is where a provider fails to provide services, potentially creating an interruption of service which is a legal violation of IDEA, as well as shortchanging the district of potential Medicaid reimbursement for those students who are Medicaid eligible. Underreporting where a provider fails to inform the district of services he or she provided, affecting Medicaid revenue reimbursement. Service gap analysis documents and compares prescribed to delivered student services to allow administrators to identify under-servicing and under-reporting. This analysis allows administrators to spot any patterns or under reporting/under servicing down to the specific provider and/or student level, and to create a culture of data driven transparent accountability.

IEP implementation. The IEP puts into place a program of instruction and services tailored to the child. IEPs must include: (1) a description of the child's present levels of educational performance; (2) how the child's disability affects the child's involvement and progress in the general curriculum; (3) a statement of measurable annual education goals, including short-term objectives; (4) a statement of the special education and related services, supplementary aids and services, program modifications, or supports for school personnel to be provided to the child, or on behalf of the child, to help the child advance toward attaining the annual goals and to be involved and progress in the general curriculum, and to participate in extracurricular and other nonacademic activities; (5) an explanation of the extent, if any, to which the child will not participate with nondisabled children in regular classes and in those activities; (6) the individual modifications in test administration needed for participation in state or district-wide assessment of student achievement; (7) how the child's progress toward the annual goals will be measured; (8) how the child's parents will be regularly informed of that progress; and (9) for older students, statements of transition needs and services, including interagency linkages. Depending upon a particular state's interpretation of the federal IDEA law, a school district has a very limited number of days to implement the child's IEP from the date of development. This cube tracks any delays in the start of the IEP.

Drop out and other exit reasons. School districts must monitor what happens to special education children: do they make sufficient progress to return to regular education, do they age out of the district (age 21), do they graduate with a diploma or a certificate, do they move away, or do they drop out. For example, do too many children drop out? If so, then the district must review and, if appropriate, revise policies, procedures, and practices that could be contributing to the unfavorable outcomes.

IEP Assessment completion. Children with suspected disabilities and previously determined disabilities must be assessed initially, and then at least every three years at the time of the reevaluation. The initial evaluation and the reevaluations must be comprehensive and must include all relevant tests, given the suspected disability, and could include cognitive, behavioral, social, emotional, physical, and developmental assessments, as well as the child's performance in the general curriculum, as a basis for accurately assessing the disability pattern, which in turn is the foundation for developing the appropriate IEP for the child. These assessments must be completed by the specific due dates.

Least Restrictive Environment (LRE). IDEA mandates that children with disabilities are to be educated in regular classes with nondisabled children, with appropriate supplementary aids and services, unless the nature or severity of the disability is such that education in regular classes with the use of supplementary aids and services cannot be achieved satisfactorily. This is known as the least restrictive environment requirement. In cases where dictated by nature or severity, schools must offer alternative placements designed to meet the child's unique needs (e.g., special classes, special schools, home instruction, and instruction in hospitals and institutions).

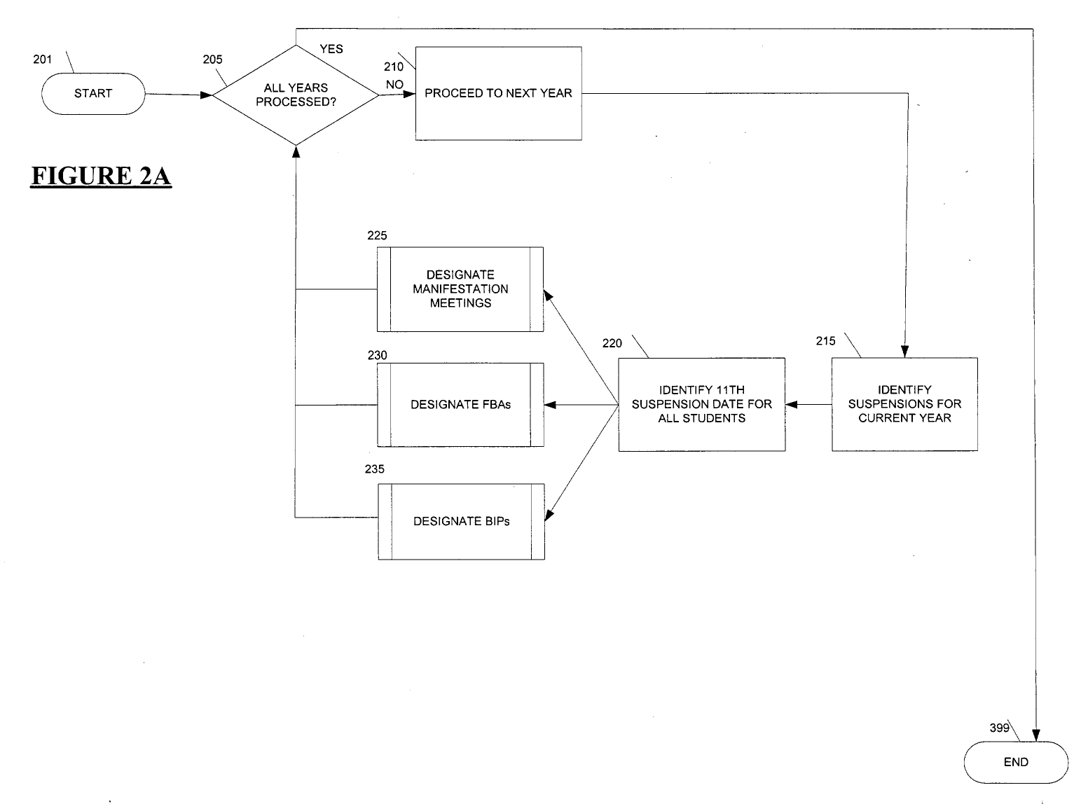

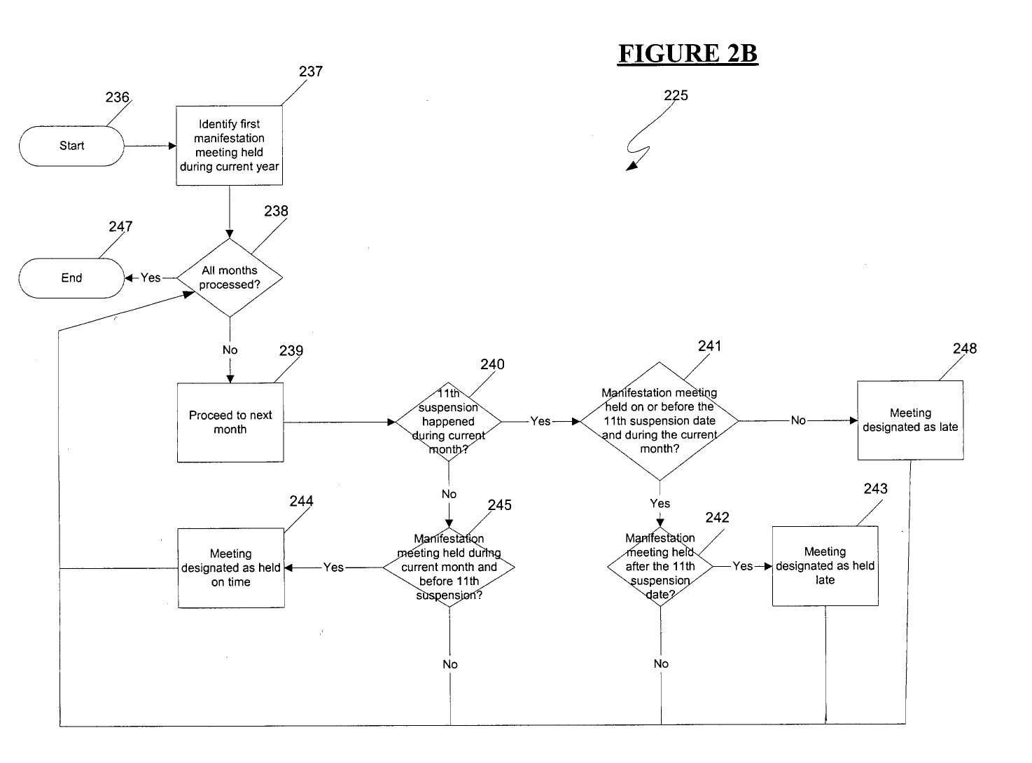

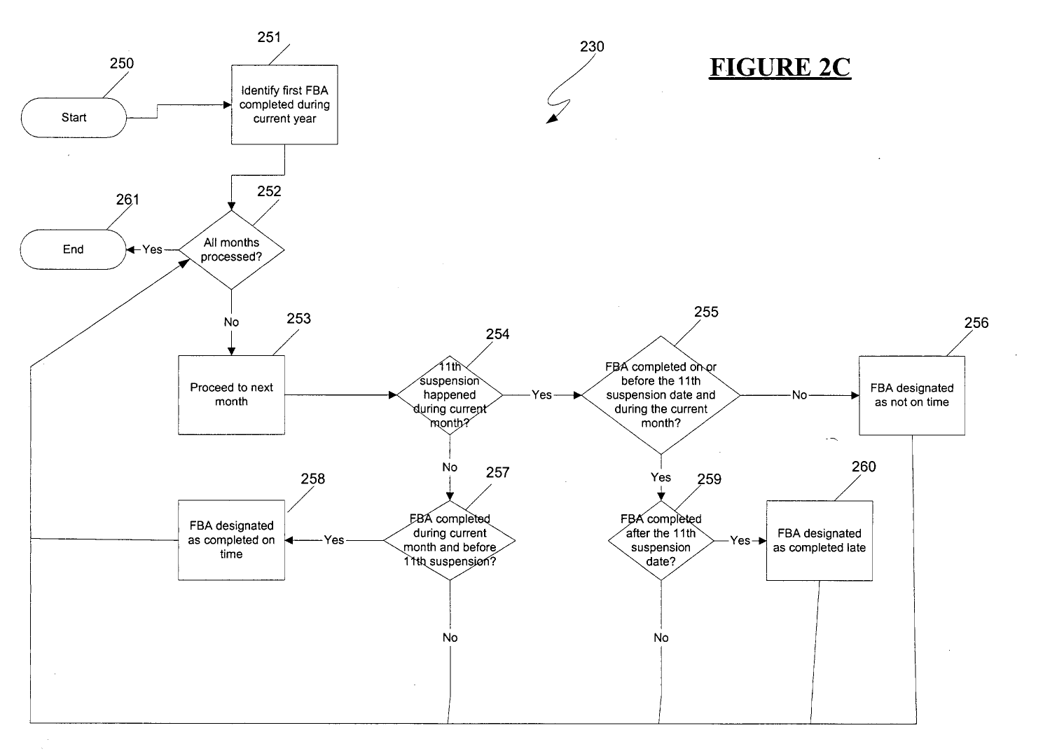

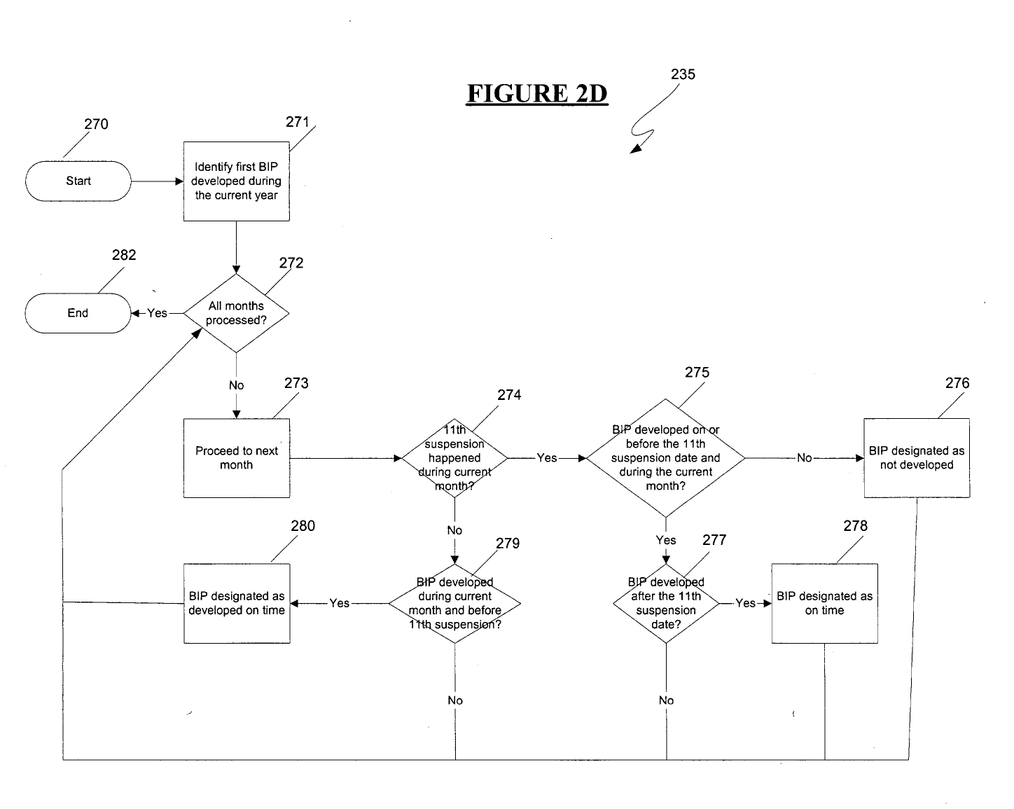

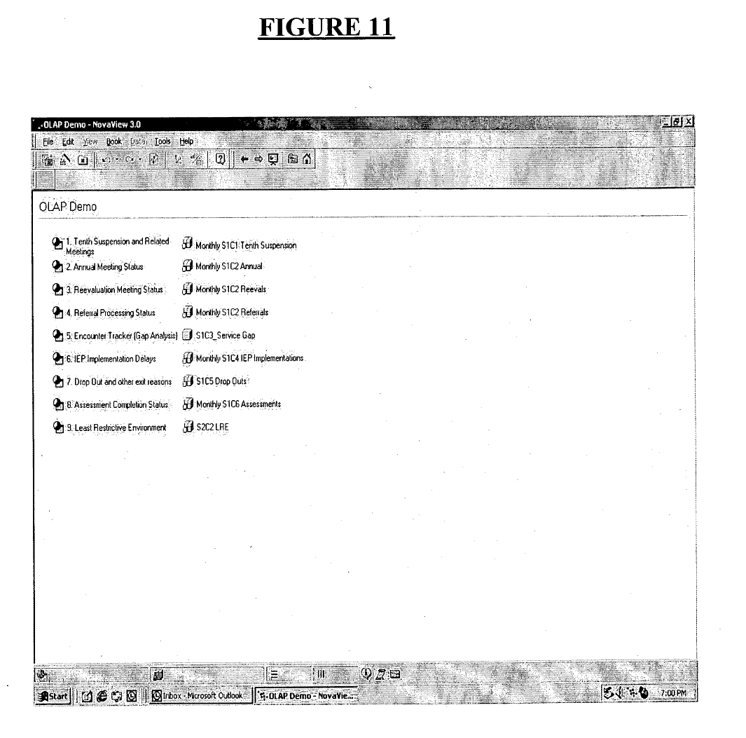

FIG. 11 is a screen shot from an example graphical user interface (GUI) illustrating overview selection options provided to a user, according to one embodiment of the present invention. Additional details of the process performed by an exemplary education outcome assessment program 110, in accordance with one embodiment of the present invention, are set out in FIGS. 2-10.

FIG. 1C illustrates a general method overview, according to an embodiment of the present invention. In 180, search criteria is accepted. In 185, an education data repository is searched to find at least one education-related data record matching the search criteria. In 190, at least one education-related data record matching the search criteria is identified.

Establishing Students' Special Education Status

According to one embodiment of the present invention, before proceeding with cube-specific processing, available and/or otherwise appropriate data in a SETS database is searched, and information about a student's presence in the special education program is collated. In one embodiment, this search includes a sophisticated review of possible events that imply the student's presence or absence from the special education program.

During this stage, at least the following data are examined: all meetings conducted, student status flags, and recorded student status changes.

In addition, the timelines are evaluated to capture events that are implied (e.g., when a new IEP was not created within one year from the previous IEP, this potentially suggests that the student left the district's special education system in the interim). Finally, the SETS implementation date is taken into account. The SETS implementation date is the date on which SETS was implemented. This information is collected and assembled in a table or other database format to be used by other queries.

In addition, in one embodiment, a separate cube is created to establish the monthly count of students. This cube counts the students enrolled in the special education program during each month and classifies them (e.g., according to gender, race, disability, age, as appropriate) to provide a reference point for the other cubes, so that, for example, statistics can be compared with the overall student population in that district. This kind of data is increasingly critical for school administrators to be able to access because of the increasing attention being paid nationally to the over representation of minorities in special education.

These features are included in many of the cubes as explained further below.

Tenth Suspension and Related Meetings Cube

In one embodiment of the present invention, the tenth suspension cube processes information one school year at a time because the tenth cumulative day of suspension is relevant within a given school year (note that the tenth cumulative day of suspension is an important matter under current law, but the invention is not limited to processing based on the tenth suspension). In the first stage, all students with suspensions are identified and suspensions counted. The date on which the eleventh suspension occurs is separately stored if there are eleven or more days of suspension during the year. The first instance of a manifestation meeting, functional behavior analysis (FBA), and behavior intervention plan (BIP) held during the year for all the students is also identified.

In one embodiment, the present invention processes all the months for the current year, processing one month at a time. For each month, the manifestation meeting, FBA and BIP dates are compared with the date of the eleventh cumulative school day of suspension.

Manifestation Meeting. The manifestation meeting status is defined as follows.

(1) For manifestation meetings, if the eleventh day of suspension occurred during the current month, if the manifestation meeting was held during the year, and if the manifestation meeting was held on or before the eleventh suspension and during the current month, the manifestation meeting is designated as held on time.

(2) If the eleventh day of suspension occurred during the current month, if the manifestation meeting was held during the year, and if the manifestation meeting was held after the eleventh suspension date, the manifestation meeting is designated as held late.

(3) If the eleventh day of suspension occurred during the current month, and the manifestation meeting was not held during the school year, the manifestation meeting is classified as not held.

(4) If the eleventh day of suspension did not occur during the current month, and the manifestation meeting was held during the current month and before the eleventh suspension date, or the year did not have eleven or more suspensions, the manifestation meeting is designated as held on time.

Behavior Intervention Plan (BIP). The BIP status is defined as follows:

(1) If the eleventh day of suspension occurred during the current month, the BIP was developed during the year, and the BIP was developed on or before the eleventh suspension and during the current month, the BIP is designated as developed on time.

(2) If the eleventh day of suspension occurred during the current month, if the BIP was developed during the year, and the BIP was developed after the eleventh suspension date, the BIP is designated as developed late.

(3) If the eleventh day of suspension occurred during the current month, and if the BIP was not developed during the school year, the BIP is designated as not developed.

(4) If the eleventh day of suspension did not occur during the current month, and if the BIP was developed during the current month and before the eleventh suspension date, or the year did not have eleven or more suspensions, the BIP is designated as developed on time.

Functional Behavior Analysis (FBA). The FBA status is defined as follows:

(1) If the eleventh day of suspension occurred during the current month, the FBA is completed during the year, and the FBA was completed on or before the eleventh suspension and during the current month, the FBA is designated as completed on time.

(2) If the eleventh day of suspension occurred during the current month, the FBA is completed during the year, and the FBA was completed after the eleventh suspension date, the FBA is designated as completed late.

(3) If the eleventh day of suspension occurred during the current month, and the FBA was not completed during the school year, the FBA is designated as not completed.

(4) If the eleventh day of suspension did not occur during the current month, the FBA was completed during the current month and before the eleventh suspension date, or the year did not have eleven or more suspensions, the FBA is designated as completed on time.

Following the procedure outlined above, FIG. 2A is a flowchart describing the tenth suspension and related meetings cube 115, according to one embodiment of the present invention. In 201, the process begins (e.g., a request is made for this information by a client.). In 205, it is determined whether all years are processed. If yes, the process proceeds to 299, where it ends. If no, the process proceeds to 210, where the next year is processed, beginning with the first year in the designated interval. In 215, suspensions for the current school year are identified. In 220, the eleventh suspension date for all students is found. In 225, the manifestation meetings are designated as held on time, held late, or not held, as further explained in FIG. 2B. In 230, the FBAs are designated as held on time, held late, or not held, as further explained in FIG. 2C. In 235, the BIPs are designated as held on time, held late, or not held, as further explained in FIG. 2D. The process then returns to 205 and repeats.

FIG. 2B is a flowchart describing the process of designating the manifestation meetings, as set forth in function 225 of FIG. 2A, according to one embodiment of the present invention. In 236, the process begins. In 237, the first manifestation meeting held during the current year is identified. In 238, it is determined whether all months in the designated interval have been processed. If yes, the process ends in 247. If no, the program proceeds to the next month in step 239. In 240, it is determined if the 11^{th} suspension happened during the current month. If the answer to 240 is yes, in 241 it is determined if the manifestation meeting was held on or before the 11^{th} suspension date and during the current month. If the answer to 241 is no, the manifestation meeting is designated as late in 248. If the answer to 241 is yes, in 242 it is determined if the manifestation meeting was held after the 11^{th} suspension date. If the answer to 242 is yes, the manifestation meeting is designated as late in 243. If the answer to 242 is no, the process returns to 238 and repeats.

If the answer to 240 is no, in 245 it is determined if the manifestation meeting was held during the current month and before the 11^{th} suspension. If the answer to 245 is yes, the manifestation meeting is designated as on time in 244. If the answer to 245 is no, the process then returns to 238 and repeats.

FIG. 2C is a flowchart describing the process of designating the FBAs, as set forth in function 230 of FIG. 2A, according to one embodiment of the present invention. In 250 the process begins. In 251, the first FBA completed during the current year is identified. In 252, it is determined whether all months in the designated interval have been processed. If yes, the process ends in 261. If no, the program proceeds to the next month in 253. In 254, it is determined if the 11^{th} suspension happened during the current month. If the answer to 254 is yes, in 255, it is determined if the FBA was held before the 11^{th} suspension date and during the current month. If the answer to 254 is no, in 257 it is determined if the FBA was held in the current month and before the 11^{th} suspension. If the answer to 257 is yes, the FBA is designated as on time in 258. If the answer to 257 is no, the process returns to 252 and repeats.

If the answer to 255 is yes, in 259 it is determined if the FBA was completed after the 11^{th} suspension date. If the answer to 255 is no, the FBA is designated as on time in 256. If the answer to 259 is yes, the FBA is designated as completed late in 260, and then the process returns to 252 and repeats. If the answer to 259 is no, the process returns to 252 and repeats.

FIG. 2D is a flowchart describing the process of designating the BIPs, as set forth in function 235 of FIG. 2A, according to one embodiment of the present invention. In 270 the process begins. In 271, the first BIP developed during the current year is identified. In 272, it is determined whether all months in the designated interval have been processed. If yes, the process ends in 282. If no, the program proceeds to the next month in 273. In 274, it is determined if the 11^{th} suspension happened during the current month. If the answer to 274 is yes, in 275, it is determined if the BIP was developed on or before the 11^{th} suspension date and during the current month. If the answer to 275 is yes, it is determined if the BIP was developed after the 11^{th} suspension date in 277. If the answer to 277 is no, the BIP is designated as not developed in 276. If the answer to 277 is yes, the BIP is designated as on time in 278. If the answer to 277 is no, the process returns to 272 and repeats.

If the answer to 274 is no in 279, it is determined if the BIP was developed during the current month and before the 11^{th} suspension. If the answer to 279 is yes, the BIP is designated as on time in 280. If the answer to 279 is no, the process returns to 272 and repeats.

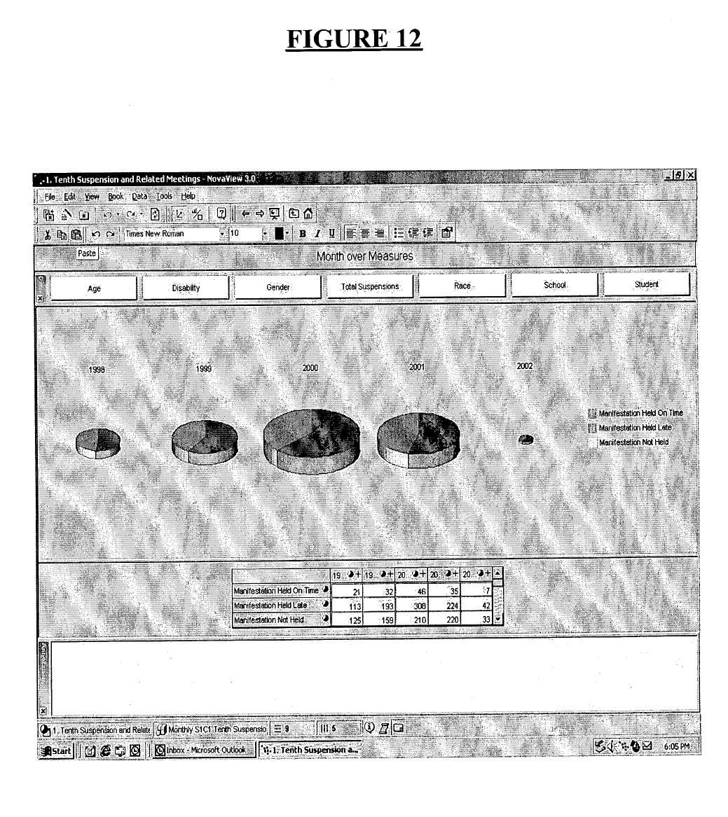

FIG. 12 is a screen shot illustrating the output produced for a typical scenario of the tenth suspension and related meetings cube as experienced by a user, according to one embodiment of the present invention. The additional dimensions of the tenth suspension cube include, for example, age, disability, gender, total suspensions, race, school, and student (note that any other criteria included in the repository of data could similarly be used for such categories). In this example, the age category includes, for example, all ages, as well as each individual age from 2 through 23. The disability category includes, for example, all disabilities, autism, deafness, deaf-blindness, developmental delay, emotional disturbance, hearing impaired, mental retardation, multiple disabilities (other than deaf-blindness), no disability, orthopedic impairments, other health impairments, specific learning disabilities, speech or language impaired, student in need of assessment, traumatic brain injury, and visual impairments (including blindness). The gender category includes, for example, all genders, female, and male. The total suspensions category includes, for example, all total suspensions, and individual numbers of suspensions from 0 through 328. The race category includes, for example, all races, African American, American Indian or Alaska Native, Asian or Pacific Islander, Hispanic, unknown or other, and White. The school category includes, for example, all schools, preschools, elementary schools, middle schools, high schools, and other schools, as well as the ability to view each individual school. The student category includes, for example, all students, and the ability to view each student individually. The power of this kind of cube with the additional dimensions is that school administrators, in a point and click browser based environment, can quickly see the nature and extent of district wide issues around violations of federal and state law around how district staff are handling children who are in special education and who go beyond ten cumulative days of suspension in a school year. Administrators can look at longitudinal trends across multiple years. They can also “drill down” in the cube to see month by month patterns emerge (e.g., did the professional development class we just offered school staff have any impact of staff behavior?). Administrators can quickly use the dimensions to see if there are different staff patterns depending upon the disability of the child, or depending upon the school building in the district. This kind of data access directly supports district administrators move to data driven management styles, which help the district operate more efficiently while simultaneously getting instructional outcomes for the child.

The tenth suspension and related meetings application is described further in U.S. Provisional Application Serial No. 60/369,557, filed Apr. 4, 2002 and U.S. Provisional Application Serial No. 60/385,877, filed Jun. 6, 2002.

Annual Meeting Status Cube

In an embodiment of the present invention, the annual meeting status cube determines the status of annual meetings identified for each month. The month being processed is the current month. Processing begins with the first month in the period and continues until all months have been processed in the designated interval.

Federal law requires an annual meeting no more than one year from the prior annual meeting. Trigger events, such as the previous annual meetings or an initial IEP, create an internal due date for the annual. Earlier timelines than one year for a particular child in the main SETS database may also be set and monitored, if the IEP team wants to review the child's IEP sooner than one year, they can manually create an internal due date earlier than one year.

In cases where the SETS implementation is new and the old data are not reliable, for example, another step of checking the student status is used. A student listed as a special education student gains this status through one of the trigger events. If no such event can be identified for the student, the earliest day on which the student was known to be in special education is taken as the trigger date.

To identify the relevant trigger events, all possible trigger events for all students are listed. The trigger events include: the most recent of all annual meetings held before the start of the current month; the most recent of all initial IEPs created before the start of the current month; and the oldest of all instances when the student was known to be a special education student before the start of the current month. Only dates where the special education status did not terminate from that date until the month start are used. The correct trigger event is the most recent of the events listed above.

The annual meeting held during the current month are identified and the students' annual meetings are designated as follows: if the annual meeting was held later than the internal due date for the next annual, which has normally been set to be no more than one year after the trigger event, it is designated as held late; if the annual meeting was less than one year after the internal due date, it is designated as held on time; if no annual meeting was held during the month, it is designated as not held; if the trigger event happened more than one year before the month end, the annual meeting is designated as not held, as long as the child is still enrolled in the district and has not exited special education. If the trigger event happened less than one year before the month end, the student is not counted. If no trigger event was found and no annual meeting was recorded in the current month, that student is not counted.

During these checks, the student's special education status is reviewed to ensure that this status did not terminate during the period. If the special education status terminated during this period, the student is not counted.

Following the procedure outlined above, FIG. 3 is a flowchart describing the annual meetings status cube 120, according to one embodiment of the present invention. In 305, it is determined if all months have been processed. If yes, all months have been processed, the program proceeds to 399, and stops. If no, all months have not been processed, in 310 the process proceeds to the next month, beginning with the first month of the designated interval. In 315, it is determined whether all students have been processed. If yes, all students have been processed, the program proceeds to 399 and ends. If no, all students have not been processed, the program proceeds to 320, where a student is identified to process.

In 325, all previous annuals for the student are identified. In 330, the initial meeting for the student is identified. In 335, any other trigger event for the student is identified. In 340, relevant trigger events are identified. In 345, it is determined whether the student left the special education program during the specified interval. If yes, the student left the special education program, the process returns to 315 and repeats. If no, the student did not leave the special education program, the process proceeds to 355, where it is determined whether an annual meeting was held during the current month. If yes, an annual meeting was held, in 360 it is determined if the current month's annual meeting was held more than one year after the previous annual meeting. If yes, it was more than one year, in 365 the student is designated as having received a late annual meeting. The process returns to 315 and repeats.

If the answer to 360 is no, the annual meeting was not held more than one year after the previous annual meeting, in 370 the student is designated as having received an on time annual meeting. If the answer to 355 is no, the annual meeting was not held during the current month, the process moves to 375 where it is determined if the annual meeting was due by the end of the month. If no, the process returns to 315 and repeats. If yes, an annual meeting was due, the process moves to 380, where the student is designated as not having received an annual meeting. The process returns to 315 and repeats.

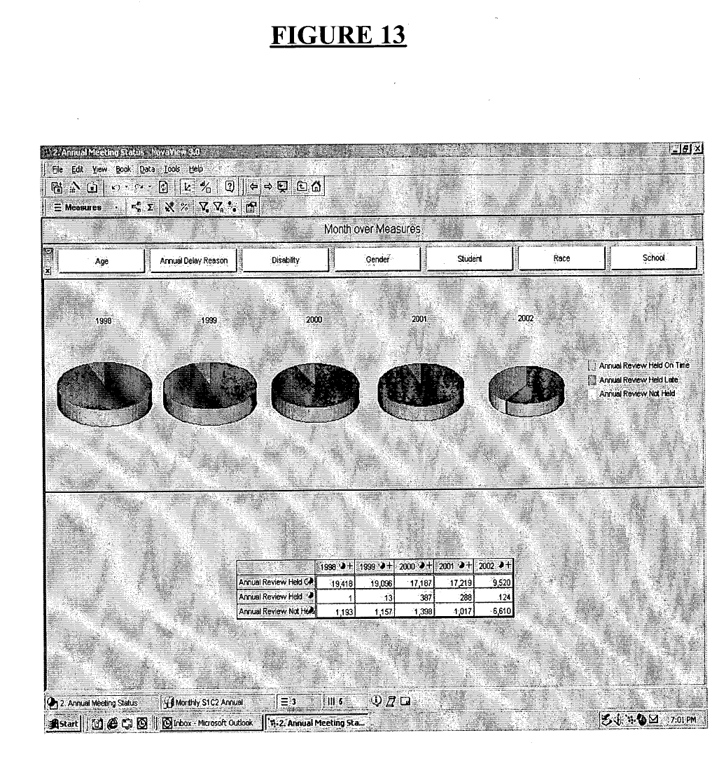

FIG. 13 is a screen shot illustrating results produced for a typical scenario of the annual meeting cube as experienced by a user, according to one embodiment of the present invention. The categories of the annual meeting status cube include, for example, age, annual delay reason, disability, gender, race, school, and student. The annual delay reason includes all reasons, no reason specified, not held, on time, parent request, provider(s) late completing test, school closed, school scheduling error, and waiting for ruling from the administrative law judge (ALJ). School districts may have additional delay reasons collected as appropriate fro their particular circumstances. Other dimensions, such as age, disability, race, gender, and school, are also all available to school administrators to apply to this data to look for patterns of behavior by district staff in their handling of annual meetings for affected children.

The annual meeting status application is described further in U.S. Provisional Application Serial No. 60/369,557, filed Apr. 4, 2002 and U.S. Provisional Application Serial No. 60/385,877, filed Jun. 6, 2002.

Re-Evaluation Meeting Status Cube

In an embodiment of the present invention, the reevaluation cube processes data one month at a time to determine the status of reevaluation meetings identified for each month. The month being processed is referred to as the current month. The first month in the period is processed, followed by the second month in the period, continuing until all the months have been processed.

Federal law requires that a reevaluation be held no later than every three years. The trigger event that sets an internal due date for this future obligation could either be a previous reevaluation meeting or an initial IEP. School staff may also set an earlier due date if they feel it is appropriate. In cases where old data is not reliable, student status must also be checked. A special education student would have gained this status through a trigger event. If no such event can be identified for the student, the earliest day on which the student was known to be in special education is taken as the trigger event date.

To identify the relevant trigger events, all possible trigger events for all students are identified. The trigger events include the following: the most recent of all reevaluations held before start of the current month; the most recent of all initial IEPs created before start of the current month; and the oldest of all instances when the student was known to be a special education student before the start of the current month. Only the dates where the special education status did not terminate from that date until the month start are used. The correct trigger event is the most recent of the events listed above.

The above approach identifies the date from which the process starts counting forward. The student must have a reevaluation meeting conducted during the three years starting from the trigger date identified. The only case where the meeting is not required is when the student leaves special education and rejoins the regular education system during this period.

Once the trigger event is correctly identified, the current month is analyzed for reevaluation meetings and these reevaluation meetings are classified as held late, held on time, and not held. To determine the correct classification, the following process is used: if a reevaluation was held during the current month, and was held past the internal due date (e.g., set to be three years after the trigger event, unless school staff have overridden the three year timeline and set it earlier due to needs of the student), the reevaluation meeting is designated as held late; if the trigger event occurred less than three years before the reevaluation in the current month, it is designated as held on time; and if the trigger event happened more than three years before the end of the month and a reevaluation meeting was not held for the in the current month, the reevaluation meeting is designated as not held. This designation process results in slight double counting because late reevaluations are counted once in the month when they become due and again when they are held. This process has been retained in order to identify the responsibility by month for the reevaluations that were delayed. The delay reason is displayed in the month when the delayed meeting is actually held.

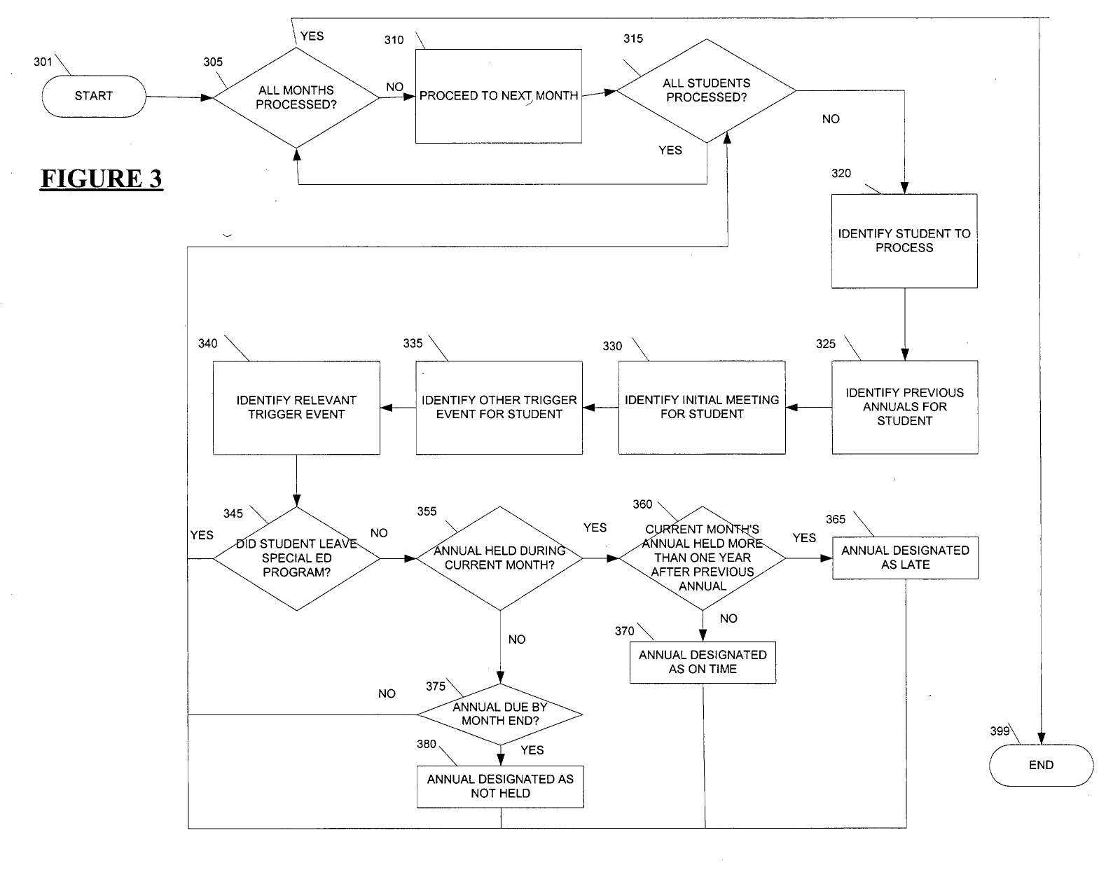

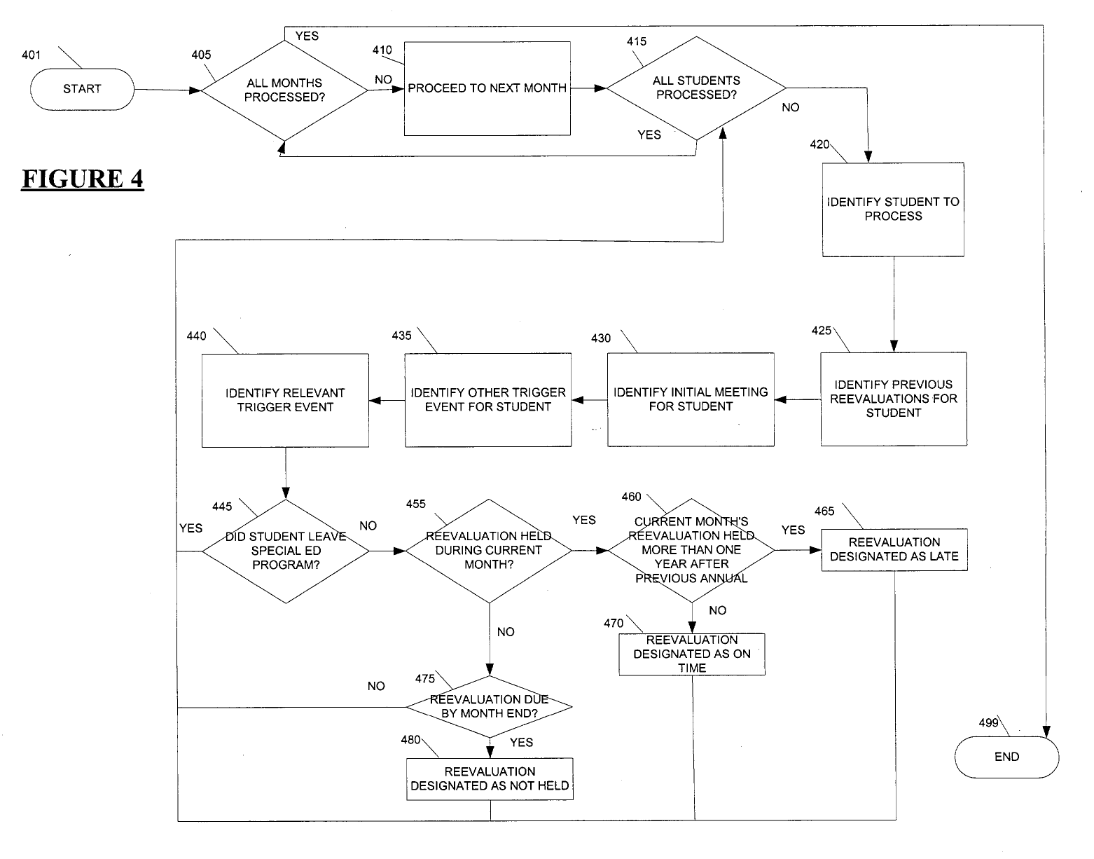

Following the procedure outlined above, FIG. 4 is a flowchart describing the reevaluation meeting cube, according to one embodiment of the present invention. In 405, it is determined if all months have been processed. If yes, all months have been processed, the program proceeds to 499, where the process stops. If no, all months have not been processed, in 410 the process proceeds to the next month, beginning with the first month in the designated interval. In 415, it is determined whether all students have been processed. If yes, all students have been processed, the program proceeds to 499, where the process stops. If no, all students have not been processed, the program proceeds to 420, where a student is identified to process.

In 425, all previous reevaluation meetings for the student are identified. In 430, the initial meeting for the student is identified. In 435, any other trigger event for the student is identified. In 440, the relevant trigger events are identified. In 445, it is determined whether the student left the special education program during the specified interval. If yes, the student left the special education program, the process returns to 415 and repeats. If no, the student did not leave the special education program, the process proceeds to 455, where it is determined whether a reevaluation meeting was held during the current month. If yes, a reevaluation meeting was held, in 460 it is determined if the current month's reevaluation meeting was held more than three years after the previous reevaluation meeting. If yes, it was more than three years, in 465 the student is designated as having received a late reevaluation meeting. The process returns to 415 and repeats. If the answer to 460 is no, the reevaluation meeting was not held more than three years after the previous reevaluation meeting, in 470 the student is designated as having received an on-time reevaluation meeting. If the answer to 455 is that no, the reevaluation meeting was not held during the current month, the process moves to 475 where it is determined if the reevaluation meeting was due by the end of the month. If no, the process returns to 415 and repeats. If yes, a reevaluation meeting was due, the process moves to 480, where the student is designated as not having received a reevaluation meeting. The process moves to 450 and repeats.

FIG. 14 is a screen shot illustrating results produced for a typical scenario of the reevaluation meeting status cube as experienced by a user, according to one embodiment of the present invention. The categories of the reevaluation meeting status cube include, for example, age, disability, gender, race, school, student, and reevaluation delay reason. The reevaluation delay reason includes, for example, all reasons, no reason specified, not held, on time, parent request, provider(s) late completing test, school closed, school scheduling error, and waiting for ruling from an Administrative Law Judge. School districts may capture additional delay reasons appropriate for them.

The reevaluation meeting status application is described further in U.S. Provisional Application Serial No. 60/369,557, filed Apr. 4, 2002 and U.S. Provisional Application Serial No. 60/385,877, filed Jun. 6, 2002.

Referrals Processing Status Cube

In an embodiment of the present invention, the data in the referrals processing status cube is processed one month at a time and the status of the eligibility meeting is identified for each month. The month being processed is described as the current month. The first month in the period is processed, followed by the next month, until all the months have been processed. The referral testing process involves very short timelines, thus an assumption is made that the data is valid and that correct data can be identified directly from SETS tables.

The trigger date for the referrals is a referral event, such as a parent or teacher request for evaluation. All referral events for all the students are identified. The students who either had an eligibility meeting during the current month or a trigger event due during the current month are identified. The students who had an eligibility meeting during the current month are classified as follows: if the eligibility meeting was held within x days (different states have set different timelines for the referral process, depending upon their interpretation of federal law) of the trigger event, it is designated as on time; if the meeting was held after x days of the trigger event, if no eligibility meeting was held, or if the trigger event was held more than x days before the end of the month, it is designated late. All other students are not counted.

Following the procedure outlined above, FIG. 5 is a flowchart describing the referral processing status cube 130, according to one embodiment of the present invention. In 505, it is determined if all months have been processed. If yes, all months have been processed, the program proceeds to 599 and ends. If no, all months have not been processed, in 510, the process proceeds to the next month, beginning with the first month of the designated interval. In 515, it is determined whether all students have been processed. If yes, all students have been processed, the program proceeds to 599 and ends. If no, all students have not been processed, the program proceeds to 520, where a student to process is identified. In 525, referral events for the student are identified. In 545, it is determined whether the student left the special education program. If yes, the process proceeds to 515 and repeats. If no, in 555 it is determined whether an eligibility meeting was held during the current month. If yes, an eligibility meeting was held, in 560 it is determined if the eligibility meeting was held more than 120 days after the pre-referral event. If yes, it was more than 120 days, in 565 the student is designated as having received a late eligibility meeting. The process returns to 515 and repeats. If the answer to 565 is that no, the eligibility meeting was not held more than 120 days after the referral event, in 570 the student is designated as having received an on time eligibility meeting. If the answer to 555 is no, the eligibility meeting was not held during the current month, the process moves to 575 where it is determined if the eligibility meeting was due by the end of the month. If no, the process returns to 515 and repeats. If yes, an eligibility meeting was due, in 580, the student is designated as not having received an eligibility meeting. The process returns to 515 and repeats.

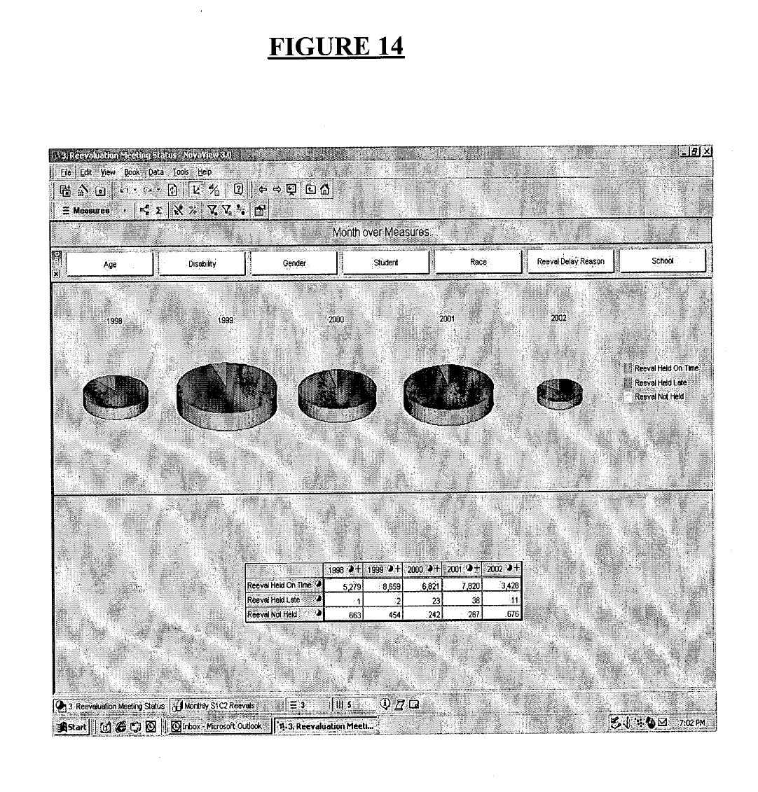

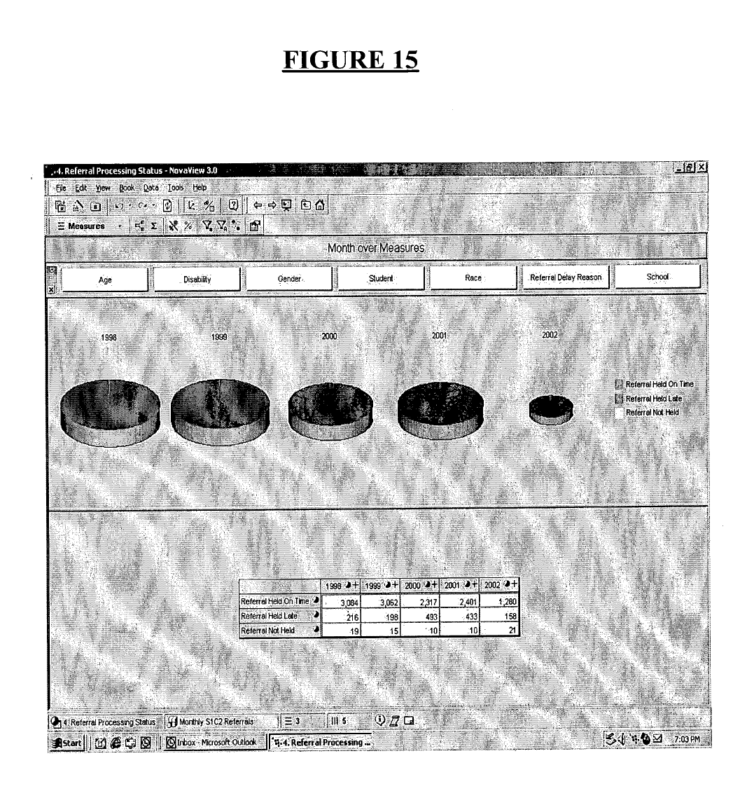

FIG. 15 is a screen shot illustrating results produced for a typical scenario of the referral processing status cube as experienced by a user, according to one embodiment of the present invention. The dimensions of the referral processing status cube include, for example, age, disability, gender, race, school, student, and referral delay reason. These dimensions allow district administrators to examine, for example, if more children of a certain suspected disability are having delays in the evaluation process than other disabilities, or if certain schools within the district are having more issues with delays than others. This is critical information for school administrators to have as they move towards data driven management styles. The referral delay reason includes, for example, all reasons, no reason specified, not held, on time, parent request, provider(s) late completing test, school closed, school scheduling error, and waiting for ruling from an ALJ. Other delay reasons could be captured by a particular school district. For example, the ability to track their relevant delay reasons give school administrators hard data by which to judge where the process may be breaking down, and to intervene appropriately.

The referral processing status application is described further in U.S. Provisional Application Serial No. 60/369,557, filed Apr. 4, 2002 and U.S. Provisional Application Serial No. 60/385,877, filed Jun. 6, 2002.

Encounter Tracker (Gap Analysis) Cube

In an embodiment of the present invention, the encounter tracker (service gap analysis) cube is implemented to view data processed and generated by an electronic Medicaid service encounter application which tracks, for example, from speech therapists, psychologists, school nurses, and occupational therapists, what actual services they have either delivered or attempted to deliver. The service gap application evaluates the prescribed services mandated under all IEPs for all students, for all months, looks at the identified provider for those services for a segment of time, looks at the actual and attempted services reported by the identified provider, and calculates the deficit or surplus services delivered. The service gap application is described further in U.S. Provisional Application Serial No. 60/422,869, filed Nov. 1, 2002. The encounter tracker (gap analysis) cube displays the service gap application information.

Following the procedure outlined above, FIG. 6 is a flowchart describing the referral processing status cube 135, according to one embodiment of the present invention. In 605, parameters for the requested data is entered. In 610, the service gap analysis is run using a service gap application. In 615, the service gap analysis data requested is displayed in a manner allowing for drill down capacity.

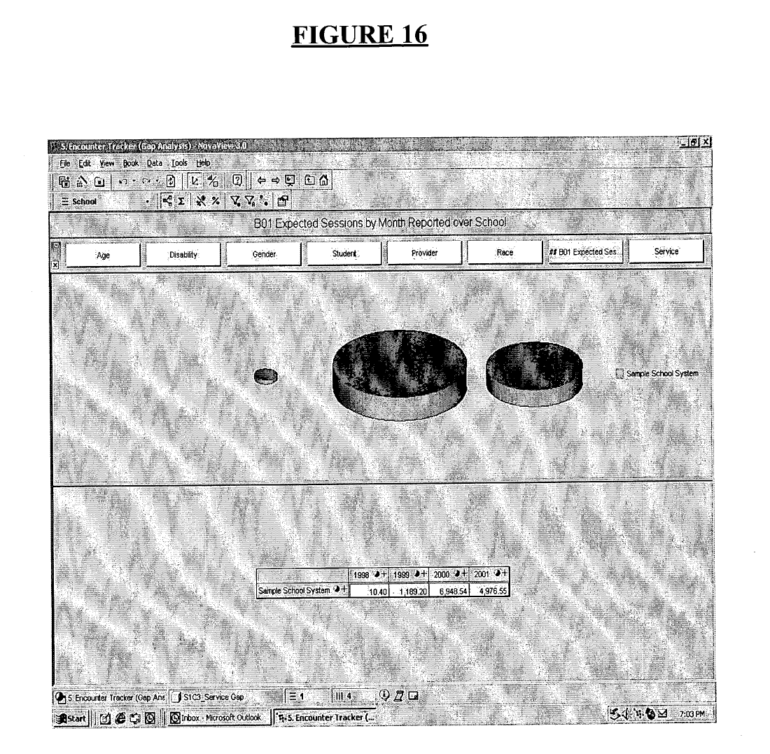

FIG. 16 is a screen shot illustrating results produced for a typical scenario of the service gap cube as experienced by a user, according to one embodiment of the present invention. The categories of the encounter tracker cube include, for example, age, disability, gender, race, school, student, provider, expected sessions, and service. The provider category identifies the provider of the special education services. The expected session students tracks the number of the expected sessions, the actual sessions, and the attempted sessions. The service category designates a category for the special education service provided. This cube allows school administrators to look across the district and to quickly identify specific providers or categories of providers who are under servicing or under reporting with their assigned children. This allows administrators to both optimize Medicaid recovery for children who are Medicaid eligible as well as to fully meet their legal obligations under IDEA.

Individual Education Plan (IEP) Implementation Delays Cube

In an embodiment of the present invention, the IEP implementation delays cube is processed one month at a time and the status of IEP Implementations is identified for each month. The month being processed is referred to as the current month. Processing begins with the first month in the period and continue until all months have been processed.

The IEP implementation due date is specified for each IEP. Depending upon the district's particular state law, the district has a specified time period from the IEP meeting to actually implement the IEP services to the child. The timeline may be different depending upon whether it was an initial IEP meeting or a renewal IEP meeting. The IEP implementation due date is compared against the actual IEP start date, as saved in an IEP encounter detail record. The result is interpreted as follows: if the IEP has no actual start date, the IEP is designated as not started; if the IEP has an actual start date, if the actual start date is before the due date, the IEP is designated as started on time; if the IEP has an actual start date, if the actual start date is not before the due date, the IEP is designated as started late.

During the checks outlined above, steps are taken to determine that the student's special education status did not terminate during the defined period. If the special education status was terminated during this period, the student is not counted.

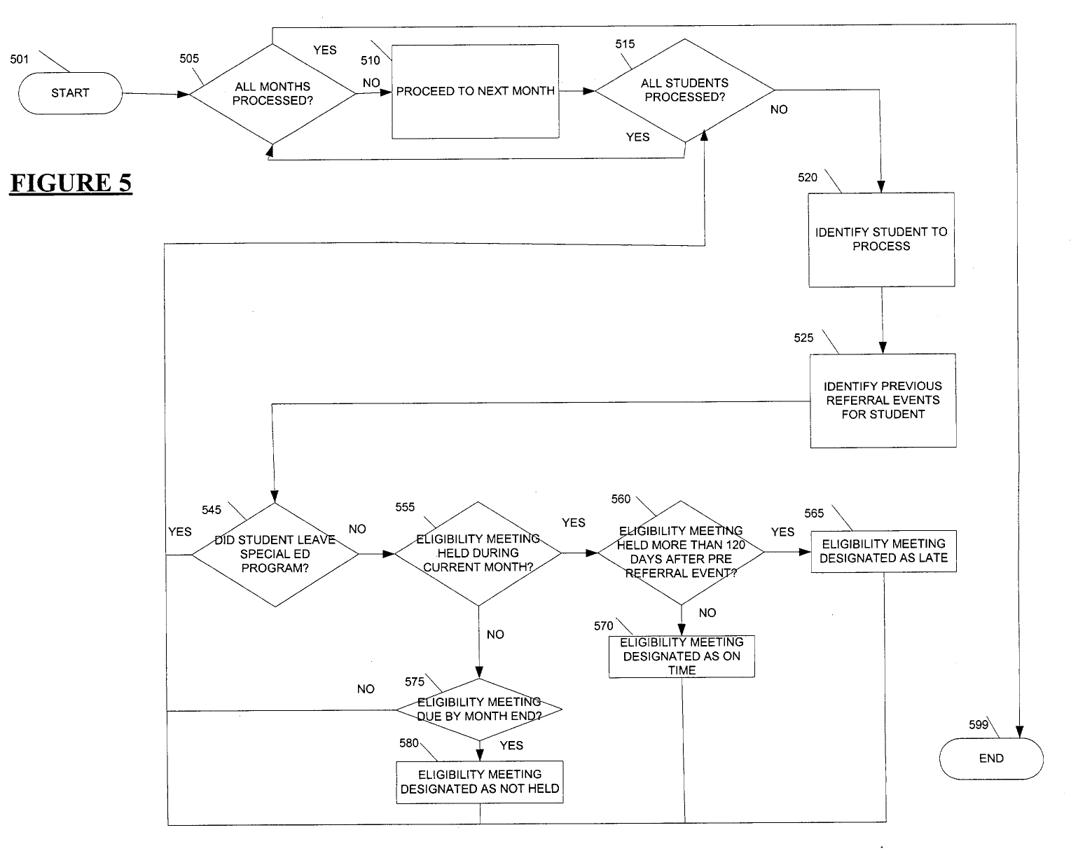

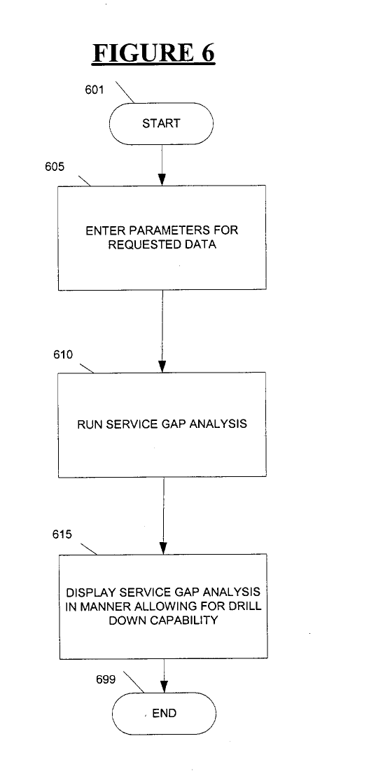

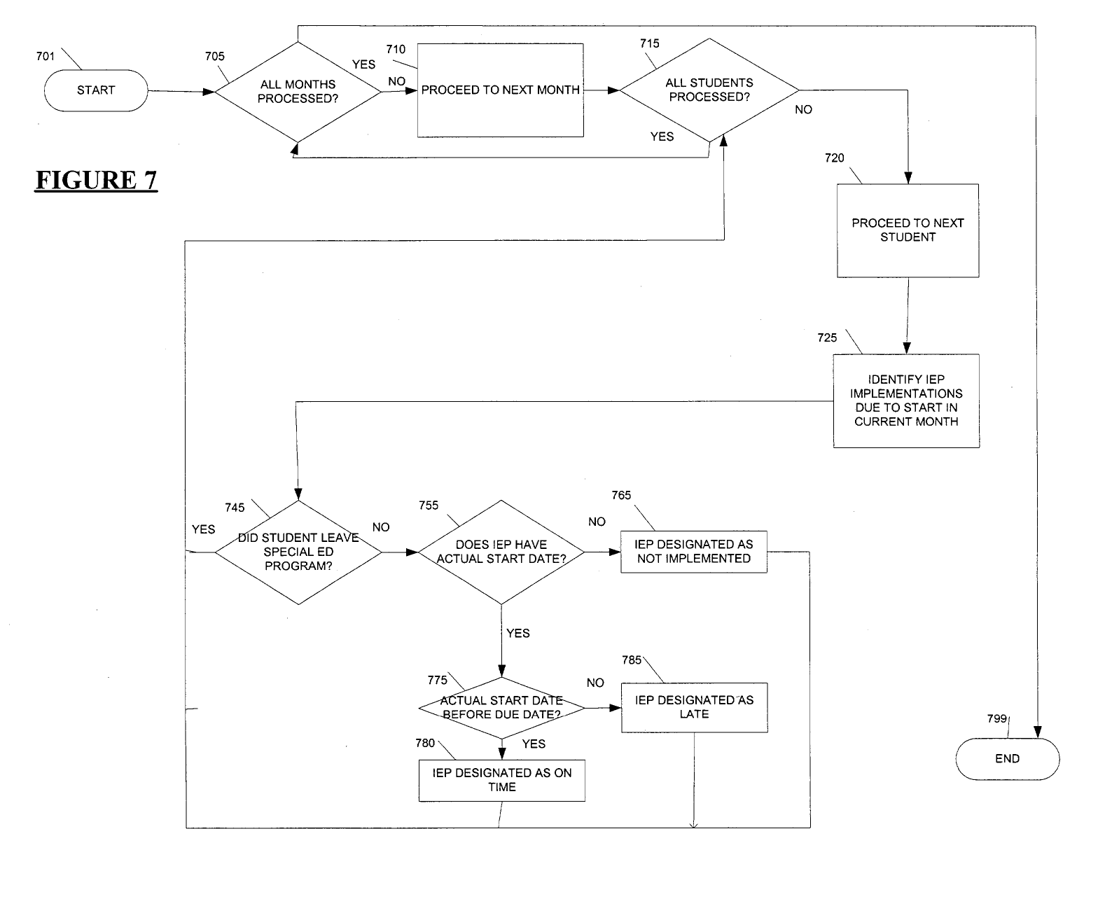

Following the procedure outlined above, FIG. 7 is a flowchart describing the IEP implementation delays cube 140, according to one embodiment of the present invention. In 705, it is determined if all months have been processed. If yes, all months have been processed, the program proceeds to 799, where the process stops. If no, all months have not been processed, in 710, the process proceeds to the next month, beginning with the first month in the designated interval. In 715, it is determined whether all students have been processed. If yes, all students have been processed, the program proceeds to 799, where the process stops. If no, all students have not been processed, the program proceeds to 720, where a student to process is identified. In 725, IEP implementations due to start in the current month for the student are identified. In 745, it is determined whether the student left the special education program. If yes, the program returns to 715 and repeats. If no, the program proceeds to 755, where it is determined whether the IEP had an actual start date. If no, in 765 the student is designated as having not received an IEP. The process returns to 715 and repeats. If the answer to 765 is yes, in 755, is it determined whether the actual start date of the IEP was before the due date. If no, the IEP is designated as late in 785. If yes, the IEP is designated as on time in 780. The process returns to 715 and repeats.

FIG. 17 is a screen shot illustrating results produced for a typical scenario of the IEP implementation delays cube as experienced by a user, according to one embodiment of the present invention. The categories of the referral processing status cube include, for example, age, disability, gender, race, school, student, and IEP delay reason. The IEP delay reason includes, for example, all reasons, diligent efforts—no response from parents, diligent efforts—parent failed to respond in timely manner, diligent efforts—parent/student whereabouts unknown, due date too close or past when student registered at school, failed to tell provider to start services, lack of transportation, late parent signature—inadequate due diligence, late parent signature—initial refusal, no parent surrogate available, no reason specified, non-public placement transition, not started, on time, parent permission refused, parent request delay until head start begins, parent requests delay until new school year, parent withdrew permission, provider did to give assigned services, student hospitalized, student in treatment center, student incarcerated, student refuses service, IEP in effect during delay, trouble assigning provider, waiting for an ALJ ruling, was not told student had registered at school, and weather delayed services. District administrators also have multiple additional dimensions that they can apply to the view, such as nature of service, school, and nature of disability. These additional views allow administrators to spot patterns, such as school psychologists in their district who are having trouble implementing their services, either district wide, or in particular buildings. Once this pattern is identified, then school administrators have data to base their investigation as to underlying causes.

The IEP implementation delays application is described further in U.S. Provisional Application Serial No. 60/369,557, filed Apr. 4, 2002 and U.S. Provisional Application Serial No. 60/385,877, filed Jun. 6, 2002.

Drop Out and Other Exit Reasons Cube

In an embodiment of the present invention, the drop out and other exit reasons cube processes data one month at a time and identifies children who have exited district special education services for each month and the reason for their exiting. These reasons are identified at the federal level for reasons such as, returning to regular education, graduating from high school, aging out (age 21), leaving the district, and dropping out. The month being processed is referred to as the current month. Processing is started with the first month in the period and continued until all the months have been processed. The students' special education status is used to identify all students who transition from special education status to non-special education status during the current month. Only students with a valid exit reason are included in the drop out cube. Students are classified based on the exit reason specified for their non-special education system. These numbers are added up to obtain the aggregate figures.

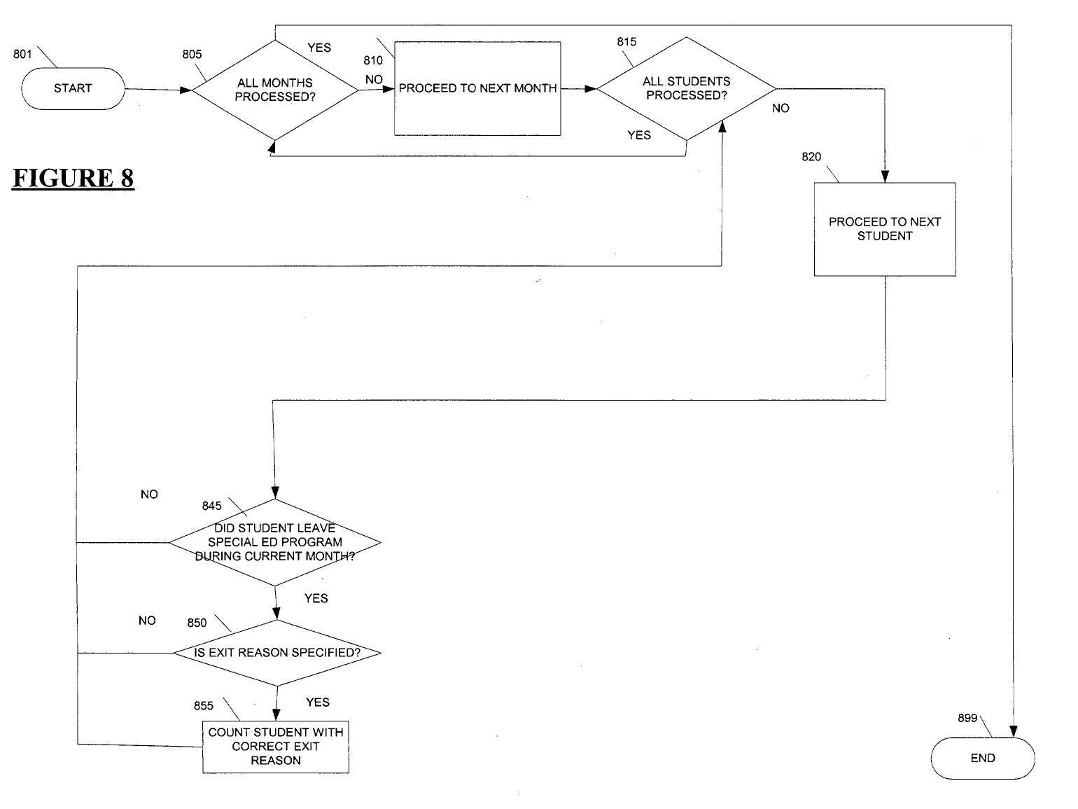

Following the procedure outlined above, FIG. 8 is a flowchart describing the drop out and other exit reasons cube 145, according to one embodiment of the present invention. In 805, it is determined if all months have been processed. If yes, all months have been processed, the program proceeds to 899, where the process stops. If no, all months have not been processed, in 810, the process proceeds to the next month, beginning with the first month in the designated interval. In 815, it is determined whether all students have been processed. If yes, all students have been processed, the program proceeds to 899, where the process stops. If no, all students have not been processed, the program proceeds to 820, where a student to process is identified. In 845, it is determined whether the student left the special education program. If no, the program returns to 815 and repeats. If yes, the program proceeds to 850, where it is determined whether an exit reason was specified. If yes, in 855 the student is counted with the correct exit reason, and the process returns to 815 and repeats. If the answer to 850 is no, the process returns to 815 and repeats.

FIG. 18 is a screen shot illustrating results produced for a typical scenario of the drop out and other exit reasons cube as experienced by a user, according to one embodiment of the present invention. Possible additional dimensions of the drop out cube include, for example, age, disability, gender, race, school, and student. For example, district administrators can identify that they may have more students dropping out of a particular disability district wide than is proportional, or that more students are leaving from a particular school than would be expected proportionally.

The drop out and other exit reasons application is described further in U.S. Provisional Application Serial No. 60/369,557, filed Apr. 4, 2002 and U.S. Provisional Application Serial No. 60/385,877, filed Jun. 6, 2002.

IEP Assessment Completion Status Cube

In an embodiment of the present invention, the IEP assessment completion status cube identifies the status of IEP assessment tests. The month being processed is referred to as the current month. Processing begins with the first month in the period and continues until all the months have been processed. All reviews that have a valid due date assigned are identified. Review due dates are set internally in the SETS database, dependant upon the relevant state and federal law that a particular school district is operating under. All tests assigned to these reviews are also identified. If a test has no actual review date, and the due date is past, the test is marked as not completed.

If the test has an actual review date, and if the review due date is before the actual review date, the test is designated as completed late. If the test has an actual review date, and if the review due date is the same as or after the actual review date, the test is designated as completed on time.

During the above process, the students' special education status is reviewed to ensure it did not terminate during this period. If the students' special education status terminated during this period, the student is not counted.

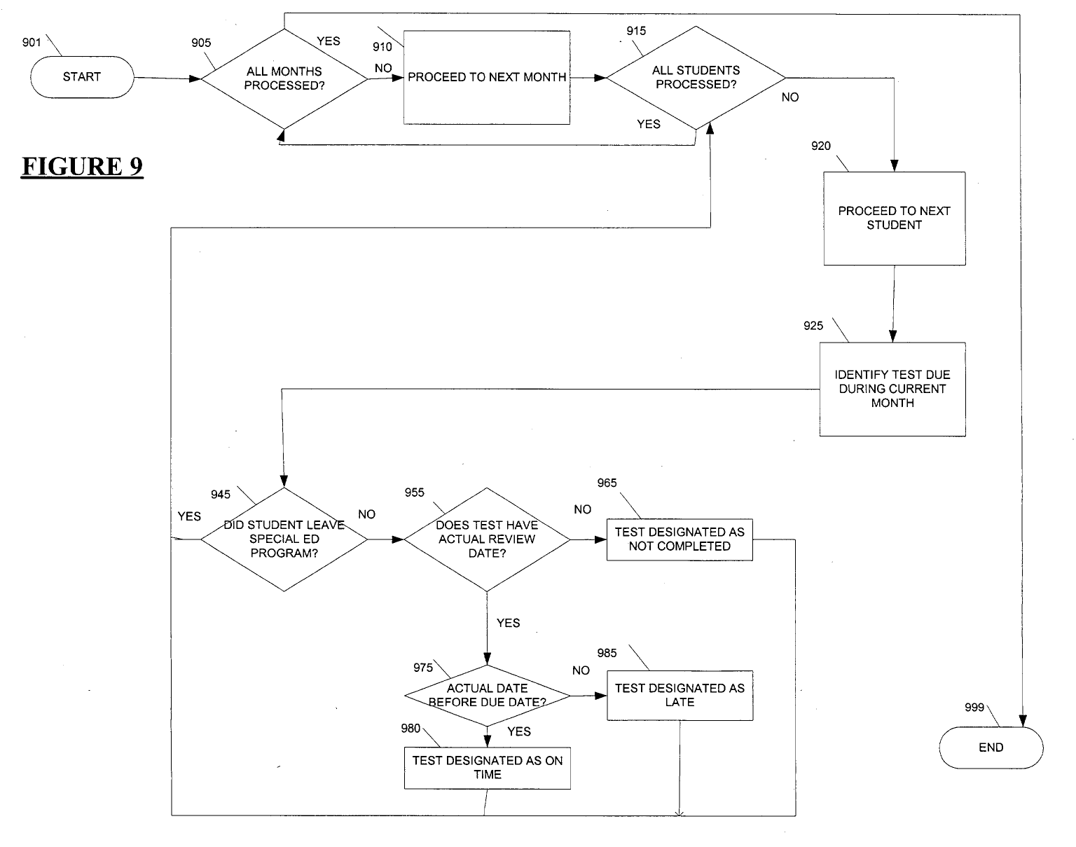

Following the procedure outlined above, FIG. 9 is a flowchart describing the assessment completion status cube 150, according to one embodiment of the present invention. In 905, it is determined if all months have been processed. If yes, all months have been processed, the program proceeds to 999, where the process stops. If no, all months have not been processed, in 910, the process proceeds to the next month, beginning with the first month in the designated interval. In 915, it is determined whether all students have been processed. If yes, all students have been processed, the program proceeds to 999, where the process stops. If no, all students have not been processed, the program proceeds to 920, where a student to process is identified. In 925, tests due in the current month for the student are identified. In 945, it is determined whether the student left the special education program. If yes, the program returns to 915 and repeats. If no, the program proceeds to 955, where it is determined whether the test had an actual review date. If no, in 965 the student is designated as having not received a test. The process returns to 915 and repeats. If the answer to 955 is yes, in 975, is it determined whether the actual date of the test was before the due date. If no, the test is designated as late in 985. If yes, the test is designated as on time in 980. The process returns to 915 and repeats.

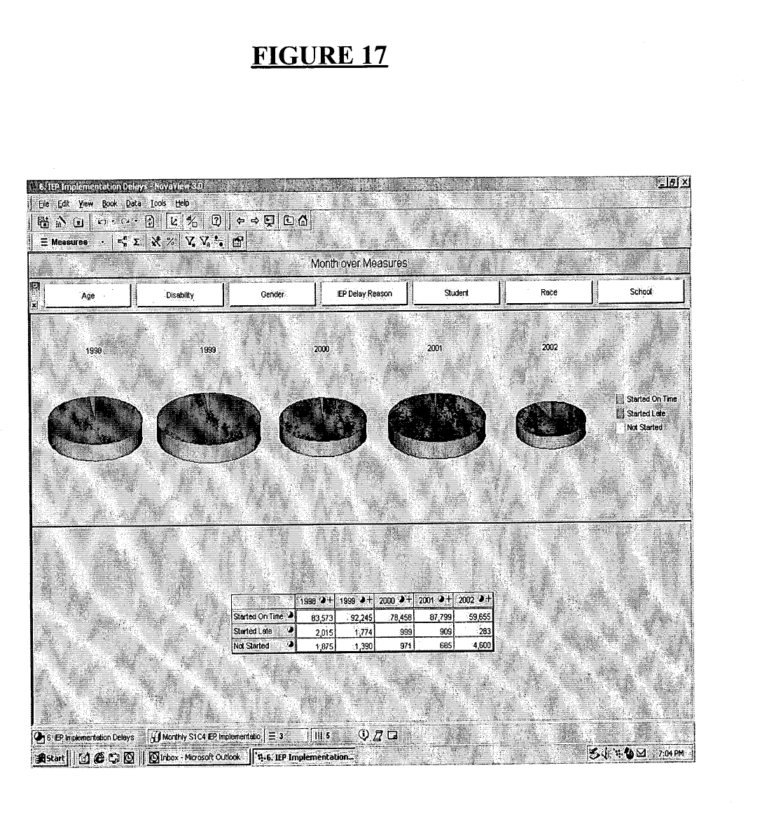

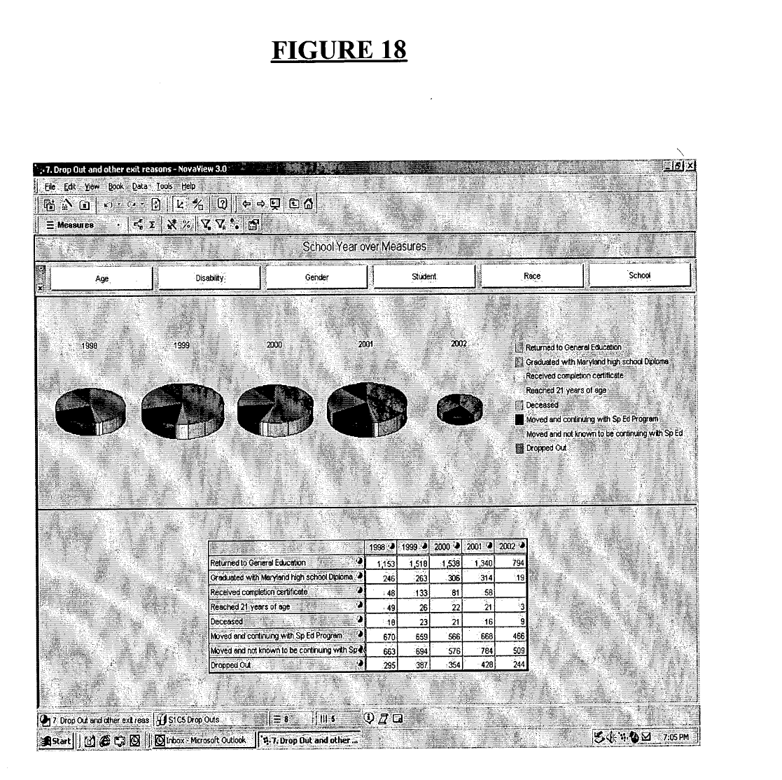

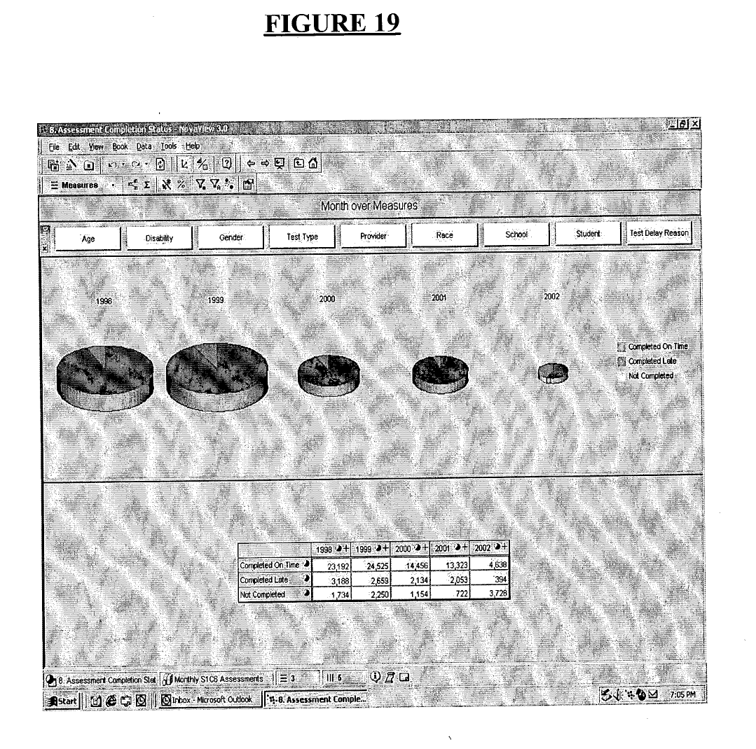

FIG. 19 is a screen shot illustrating results produced for a typical scenario of the assessment completion status cube as experienced by a user, according to one embodiment of the present invention. The dimensions of the assessment delay cube include, for example, age, disability, gender, race, school, student, provider, test type, and test delay reason. The test type dimension includes, for example, all test types, ALJ ruled no, canceled—child exited before reevaluation due date, canceled—outside agency equivalent, canceled—parent permission withdrawn, canceled—parents refuse permission, canceled—rescinded with parent agreement, evaluation, partial retest, reauthorize original, reevaluation, and write off. The test delay reason dimension includes, for example, all reasons, delay in assigning parent surrogate, delayed—parent requested outside agency assessment, delayed by need for supervisor's approval, diligent efforts—no response from parent, diligent efforts—parent failed to respond in timely manner, diligent efforts—parent/student whereabouts unknown, failed to tell provider to test student, late parent signature inadequate due diligence, late parent signature—initial refusal, no reason specified, not completed, on time, parent failed to bring student in for testing, parent permission refused, parent requested rescheduling of EP review meeting, prior school failed to do testing, provider did not complete on time, provider didn't file test on time, provider not available in student's language, student hospitalized, student in treatment center, student incarcerated, student refuses to take test, student requests break in testing session, student unavailable for testing, student under medical care, supplemental aids not immediately available (e.g., glasses), trouble assigning provider, waiting for an administrative law judge ruling, was not told student had registered as school, and weather delayed testing.

The power of the dimensions for school administrators are that they can quickly see longitudinal (historical) trends in the district, as well as current patterns affecting compliance with testing children in a timely manner. Administrators can drill down in the district data using the dimensions to see which buildings are having issues with testing, or even which providers. They can quickly see, using the delay reasons, what is affecting the timely completion of assessment, and the magnitude of the various problems. Administrators are able to differentiate the reasons which are under district control, such as a provider who fails to complete the testing on time versus those reasons not under the district control, such as a parent who fails to bring the child in for testing.

The assessment completion status application is described further in U.S. Provisional Application Serial No. 60/369,557, filed Apr. 4, 2002 and U.S. Provisional Application Serial No. 60/385,877, filed Jun. 6, 2002.

Least Restrictive Environment Cube

In an embodiment of the present invention, the LRE cube compiles data related to the students' least restrictive environments for each month. The month being processed is referred to as the current month. Processing begins with the first month in the period and continue until all months have been processed.

Applicable LREs are identified during the current month to find the applicable IEP. The first IEP valid during the current month is identified. If more than one IEP is valid during the current month, the first one is used. Using the valid IEPs for the month, the student's LRE is identified and students are grouped based on their LRE. These numbers are combined to obtain the aggregate figures.

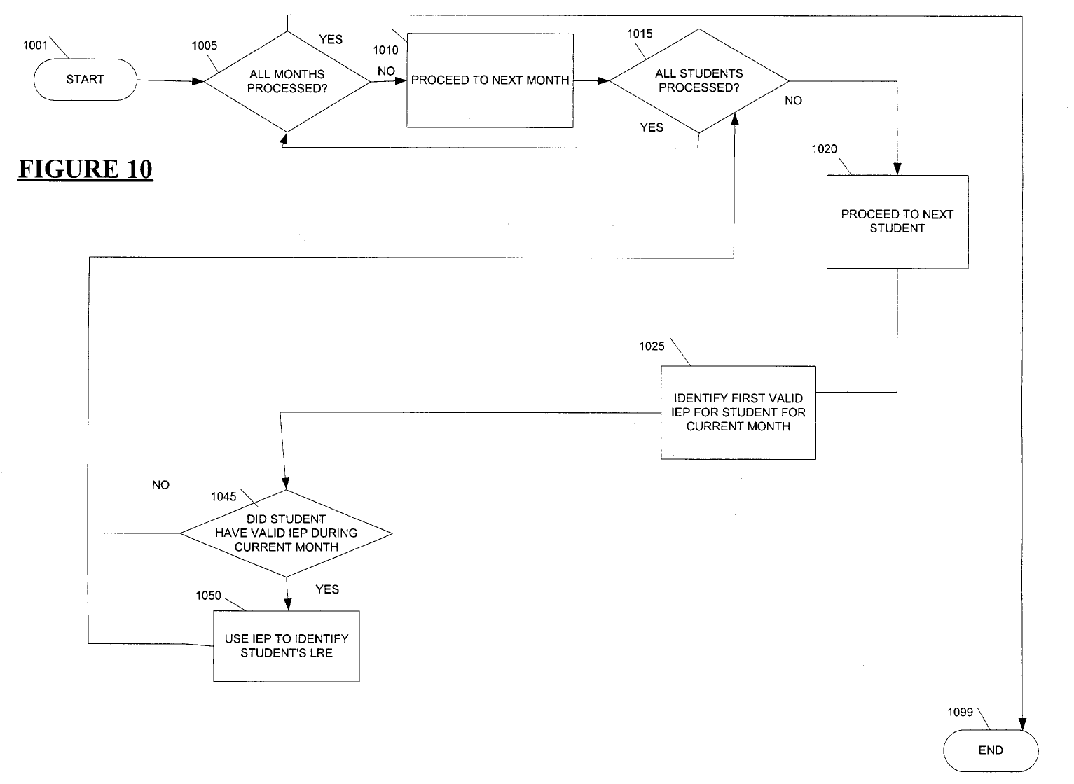

Following the procedure outlined above, FIG. 10 is a flowchart describing the LRE cube 155, according to one embodiment of the present invention. In 1005, it is determined if all months have been processed. If yes, all months have been processed, the program proceeds to 1099, where the process stops. If no, all months have not been processed, in 1010, the process proceeds to the next month, beginning with the first month in the designated interval. In 1015, it is determined whether all students have been processed. If yes, all students have been processed, the program proceeds to 1099, where the process stops. If no, all students have not been processed, the program proceeds to 1020, where a student to process is identified. In 1025, the first valid IEP for the student for the current month is determined. In 1045, it is determined whether the student had a valid IEP during the current month. If no, the program returns to 1015 and repeats. If yes, the program proceeds to 1050, where the IEP is used to identify the student's LRE. The process returns to 1015 and repeats.

FIG. 20 is a screen shot illustrating results produced for a typical scenario of the LRE cube as experienced by a user, according to one embodiment of the present invention. The dimensions of the referral processing status cube include, for example, age, disability, gender, race, school, student, and number of students in LRE. This cube enables, for example, the ability to give administrators insight into placement patterns within the district. For example, they can quickly spot if there are over representation patterns within the district, or if there are over representation patterns in self-contained classrooms for particular disabilities, ethnicities, or even genders.

The LRE application is described further in U.S. Provisional Application Serial No. 60/369,557, filed Apr. 4, 2002 and U.S. Provisional Application Serial No. 60/385,877, filed Jun. 6, 2002.

Screen Shots

FIGS. 11-20 are screen shots illustrating example GUI screens for the tenth suspension and related meetings cube, the annual meeting status cube, the reevaluation meeting status cube, the referral processing status cube, the encounter tracker (gap analysis) cube, the IEP implementation delays cube, the drop out and other exit reasons cube, the assessment completion status cube, and the LRE cube, as experienced by a user, respectively, according to one embodiment of the present invention.

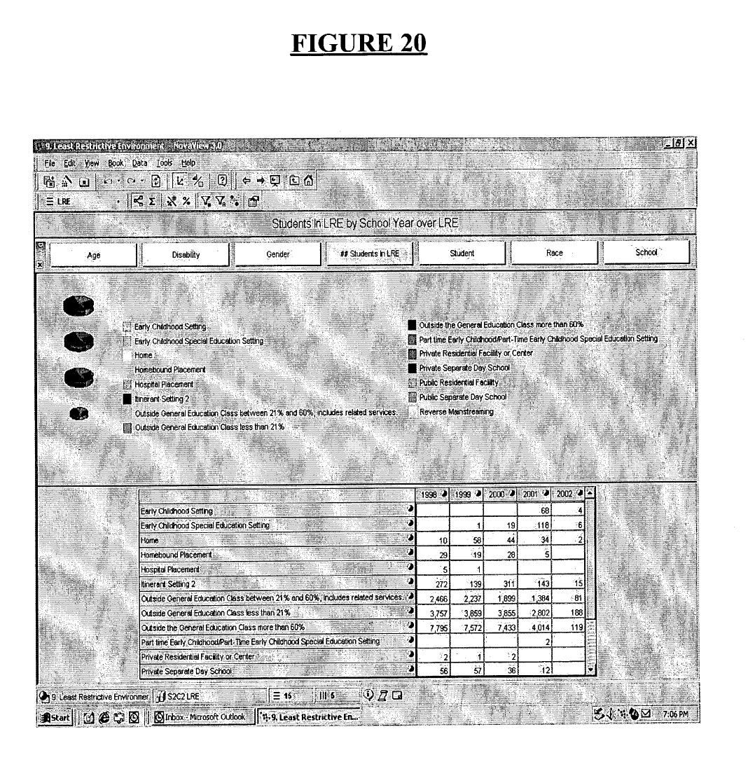

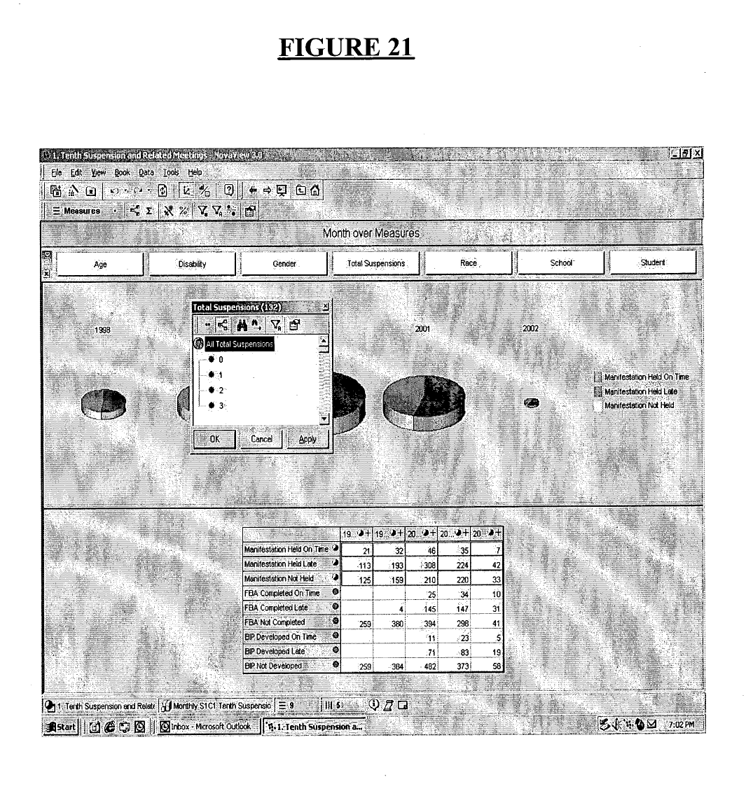

FIGS. 21-27 are screen shots for a GUI illustrating typical processing events and results, as experienced by a user accessing the various cubes, according to one embodiment of the present invention. While the tenth suspension and related meetings cube will be used to illustrate the typical scenarios, those experienced in the art will understand that these same scenarios can be applied to any of the other cubes.

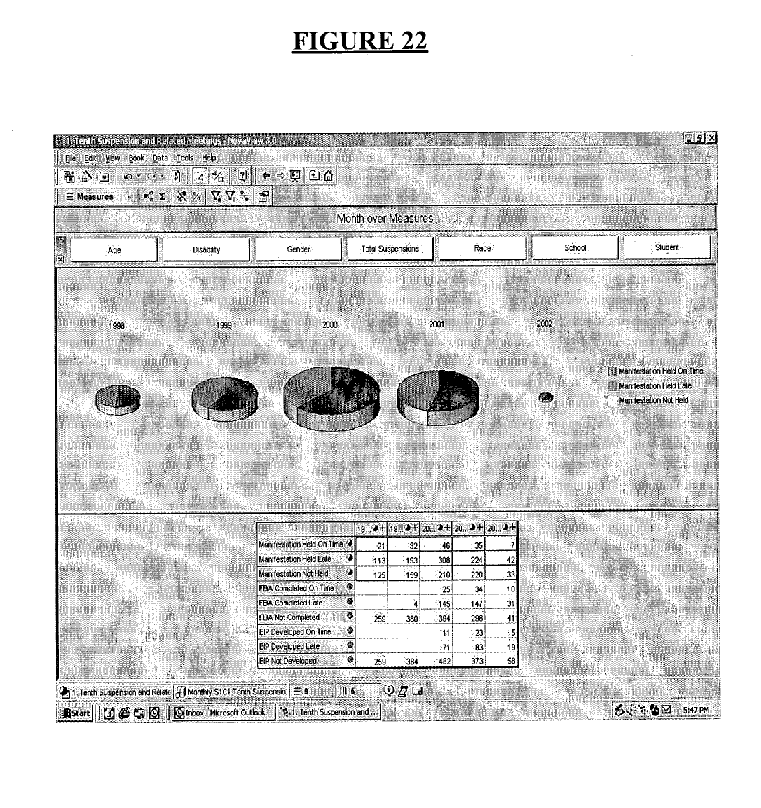

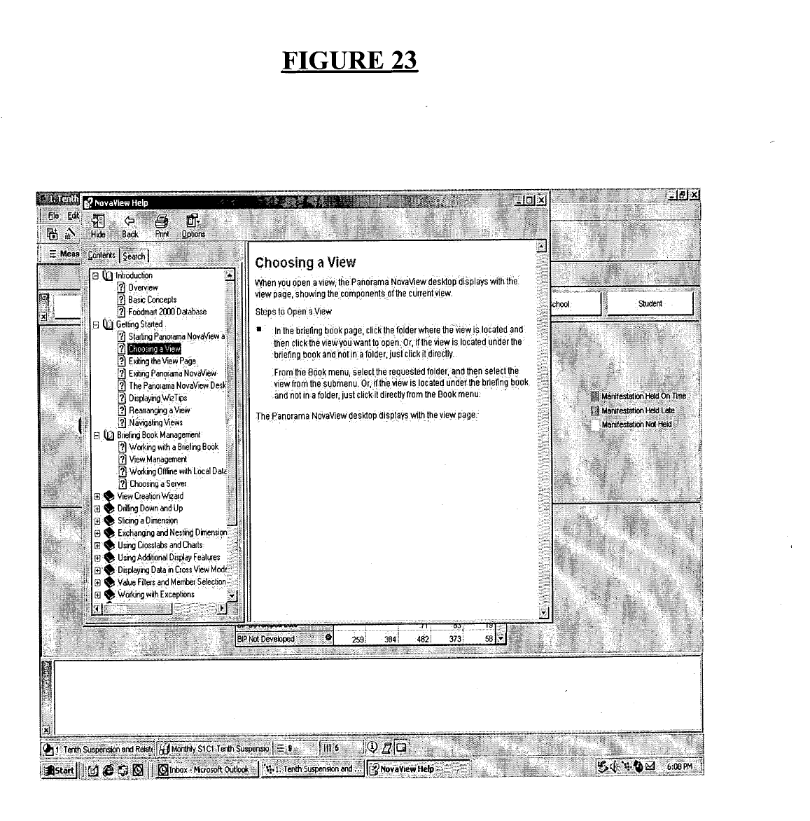

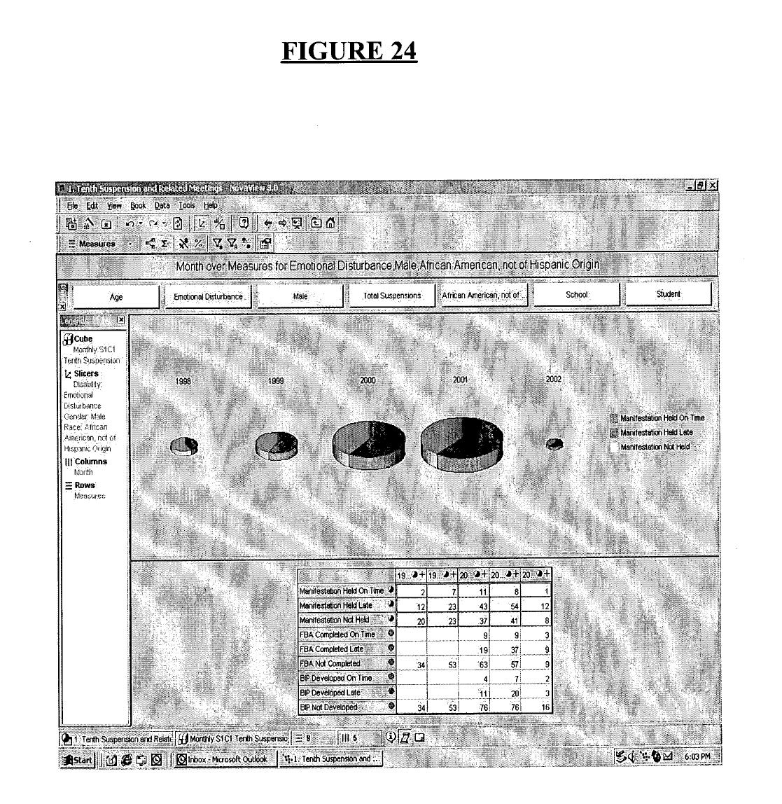

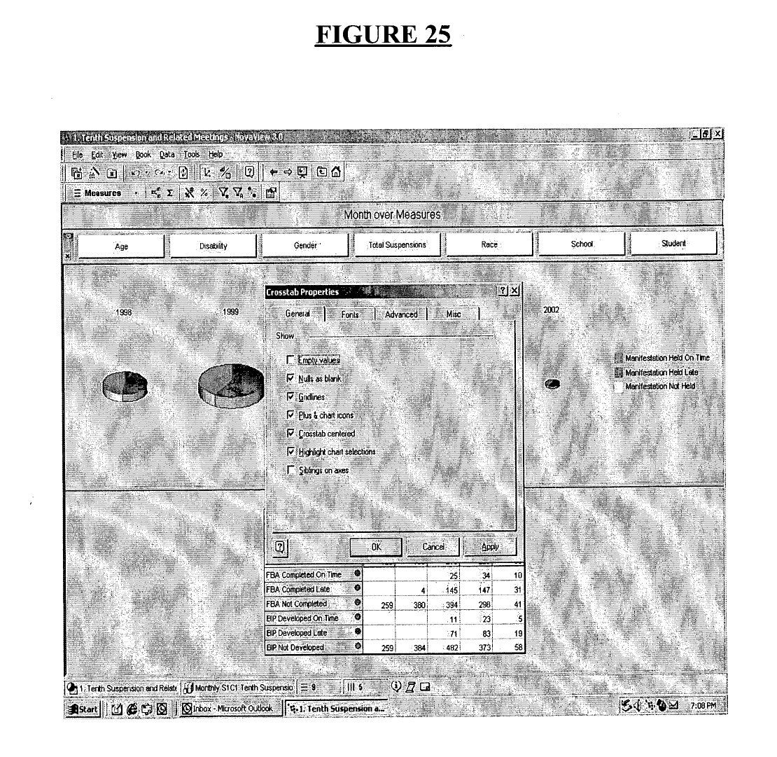

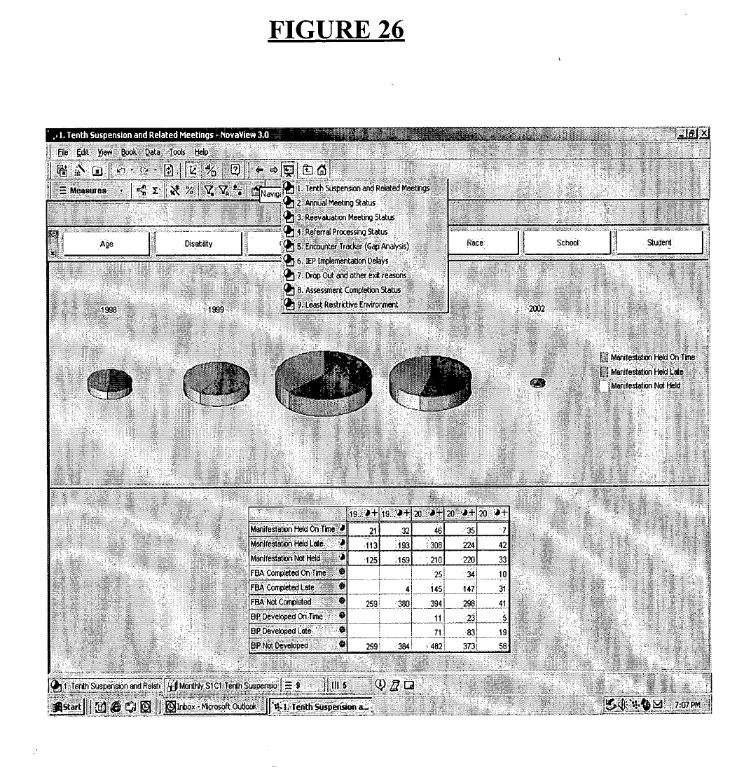

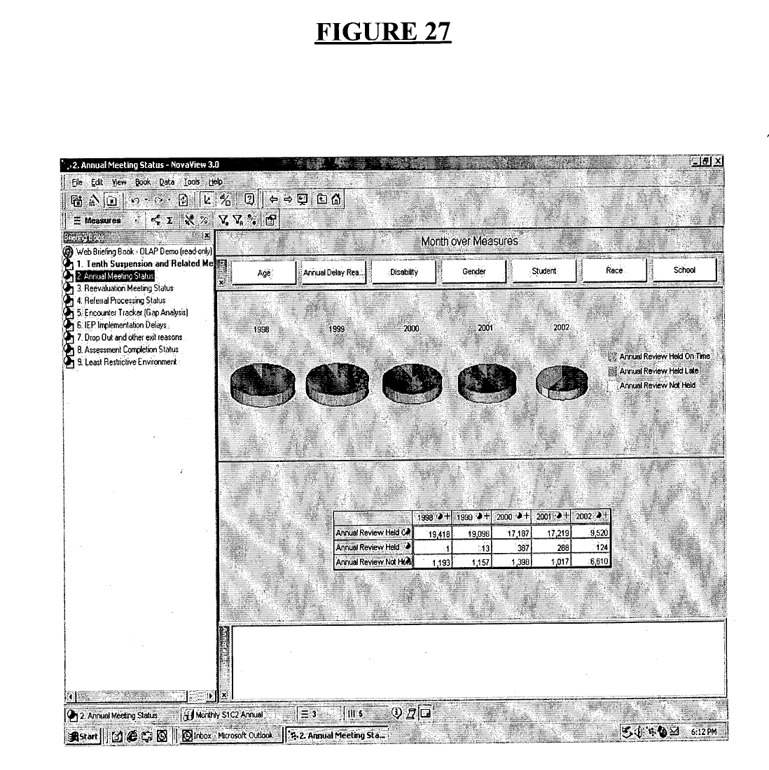

In particular, FIG. 21 is a screen shot illustrating how each category of the screen may be highlighted for additional information. In FIG. 21, the total suspensions category of the tenth suspension cube is highlighted so that the subcategories are shown. In FIG. 22, data from the categories of emotional disturbance, male (gender), and African American not Hispanic (race) are displayed in a pie chart and spread sheet form. This screen illustrates that the user can choose to pull and combine data from any of the categories and subcategories. In FIG. 23, the help option is displayed. In FIG. 24, the legend is displayed, illustrating the cube, slicer, column, and row information. In FIG. 25, the crosstab properties are illustrated. In FIGS. 26 and 27, the other cubes can be accessed directly from the current screen.

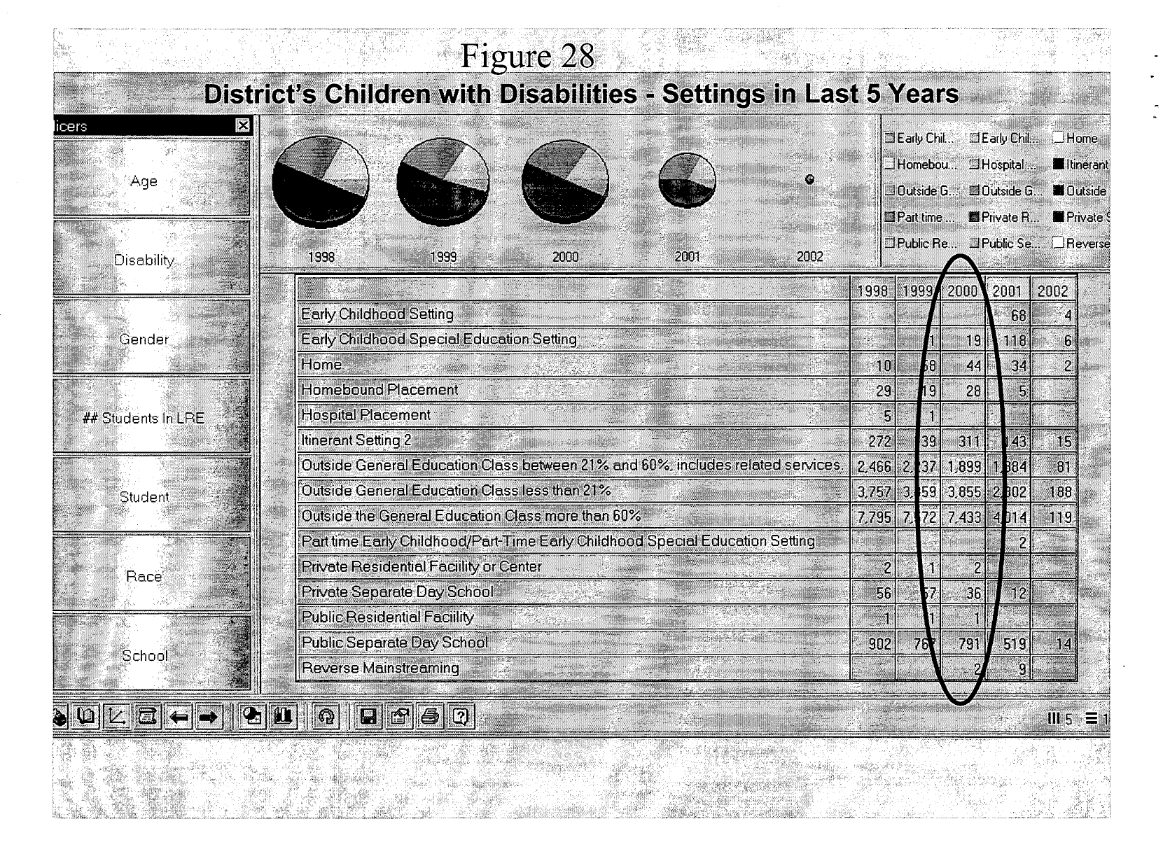

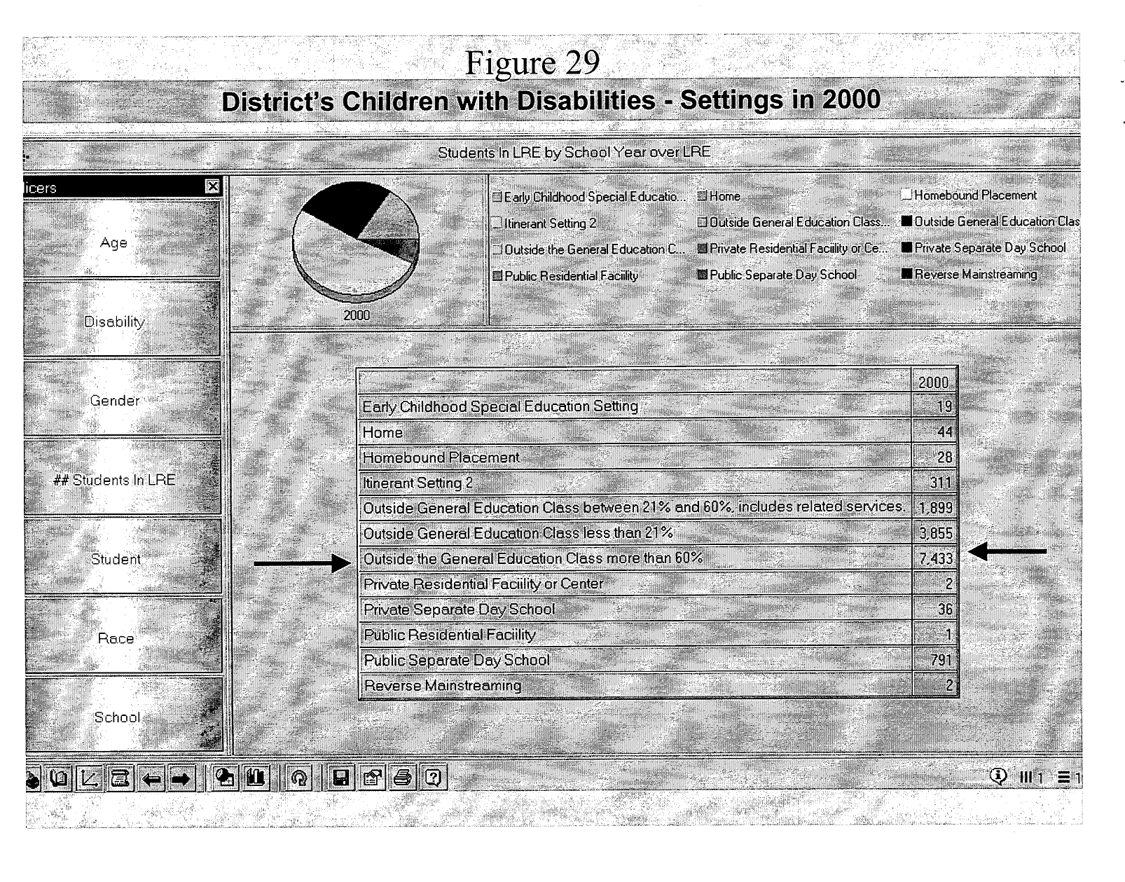

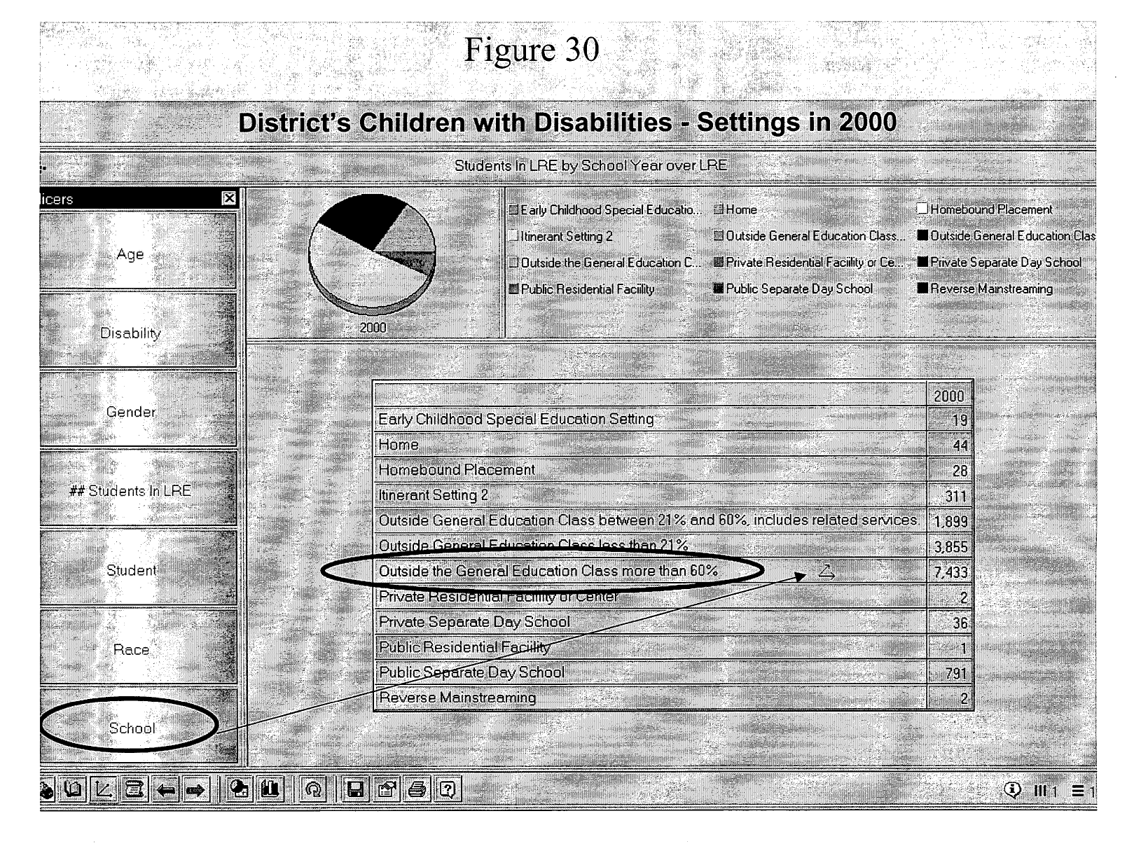

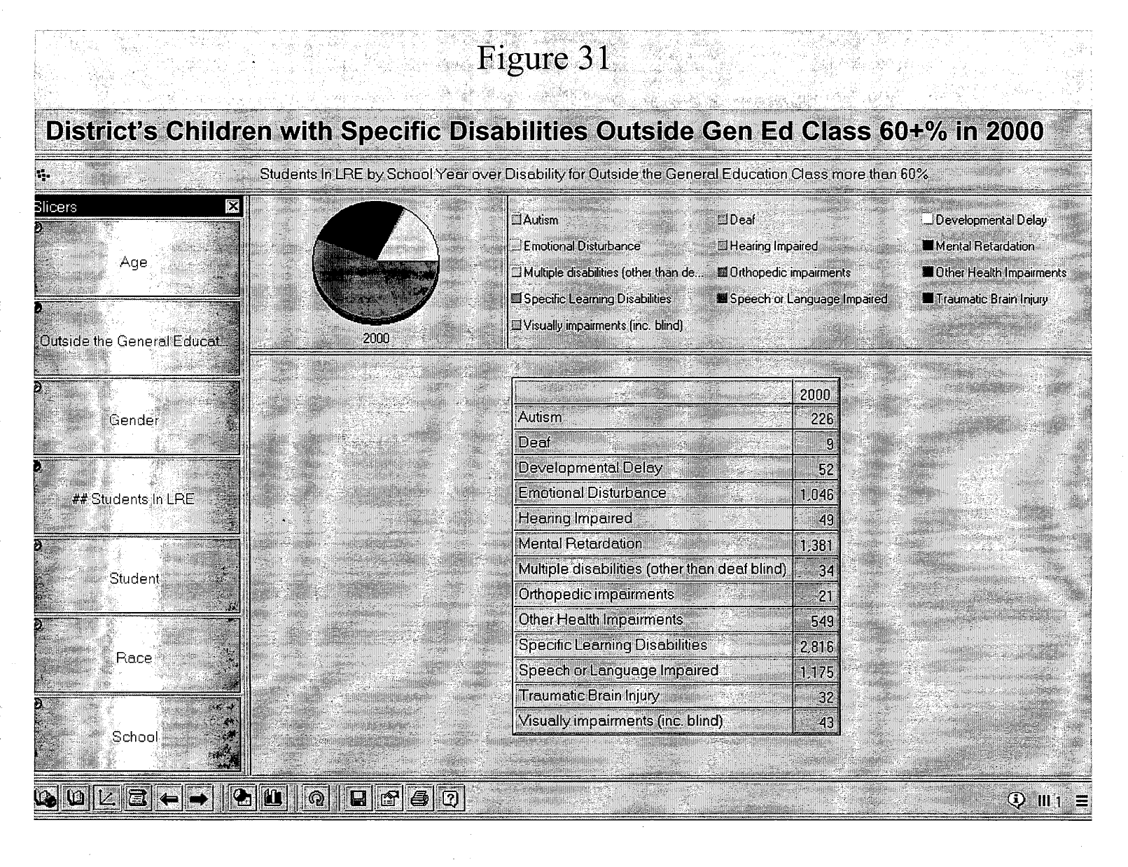

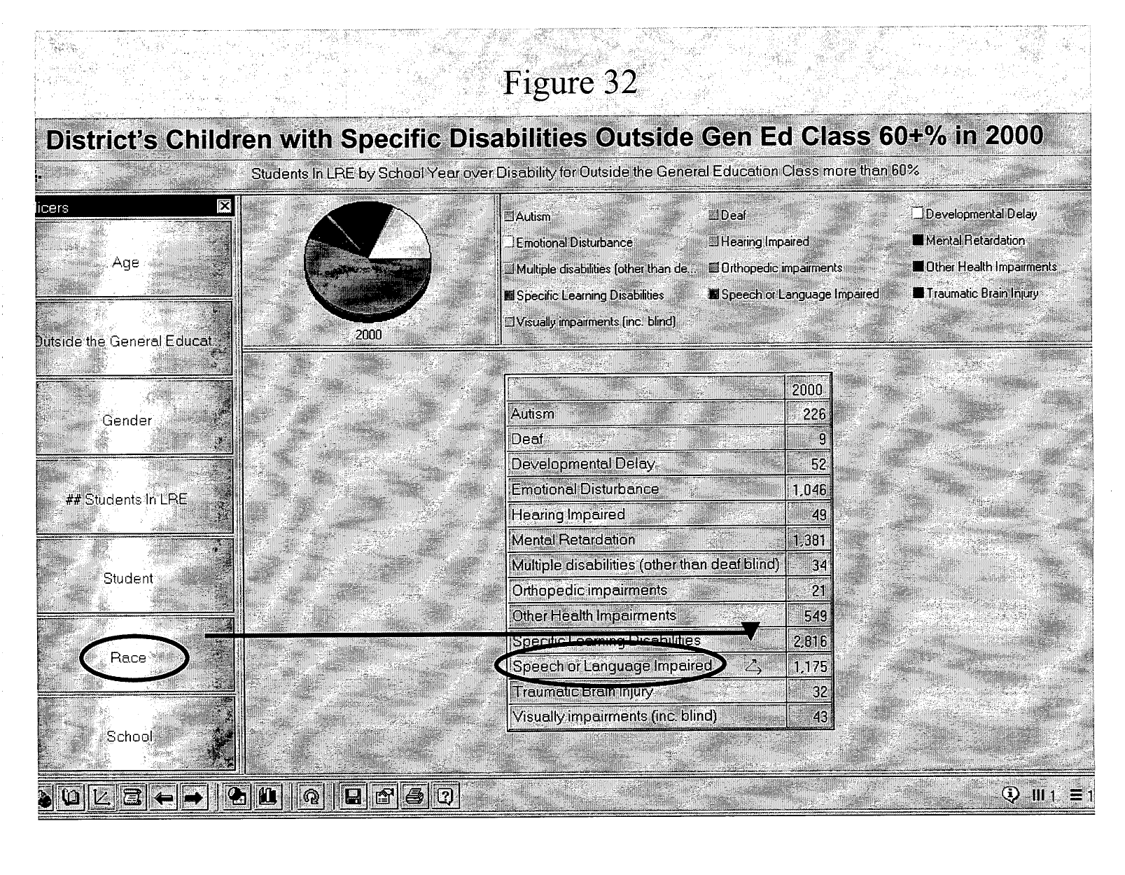

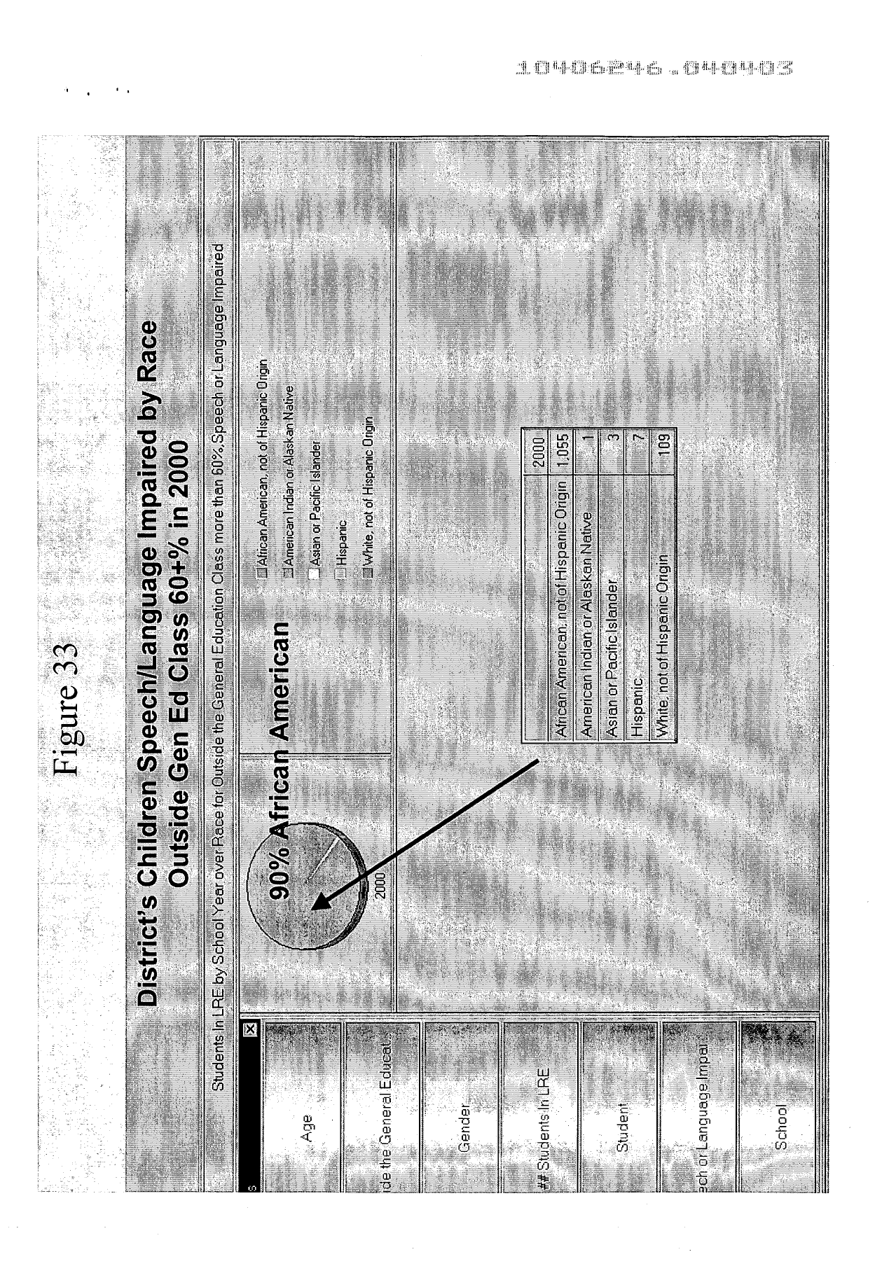

FIGS. 28-52 are screen shots exemplifying additional features, according to one embodiment of the present invention.

Example embodiments of the present invention have now been described in accordance with the above advantages. It will be appreciated that these examples are merely illustrative of the invention. Many variations and modifications will be apparent to those skilled in the art.

What is claimed is:

1. A method for analyzing data relating to at least one mandated program, the method comprising:
receiving a query;
accessing a repository of data relating to the mandated program; and
identifying data responsive to the query.

2. A method for analyzing data relating to at least one individualized instructional program, the method comprising:
receiving a query;
accessing a repository of data relating to the individualized instructional program; and
identifying data responsive to the query.

3. The method of claim 2, wherein the individualized instructional program is at least one of a group consisting of:
a special education program;
a program to prevent discrimination against a disabled student;
an English as a second language program;
an at risk program; and
a gifted and talented program.

4. The method of claim 2, wherein identifying data responsive to the query further comprises drilling down in the data to look at more detailed data.

5. The method of claim 1, wherein the mandated program includes education requirements.

6. The method of claim 1, wherein the mandated program includes special education requirements.

7. The method of claim 1, wherein receiving a query includes:
receiving a request for data meeting criteria for determining compliance with the at least one mandated program.

8. The method of claim 7, wherein receiving a request for data meeting criteria for determining compliance with the mandated program includes:
determining whether at least one triggering event has occurred within a designated time period.

9. The method of claim 8, wherein the at least one triggering event comprises at least one selected from a group consisting of:
a suspension for an individual;
an 11^{th} suspension for an individual; and
an individual education plan meeting.

10. The method of claim 8, further comprising:
if the at least one triggering event has occurred, designating a status for at least one additional action event.

11. The method of claim 10, wherein designating a status for the at least one additional action event comprises:
determining whether at least one triggering event occurred for at least one individual;
determining whether a manifestation meeting was held for the at least one individual; and
determining whether the at least one additional action event was held before the at least one triggering event.

12. The method of claim 11, wherein the at least one triggering event comprises at least one selected from a group consisting of:
a suspension for the at least one individual; and
an 11^{th} suspension for the at least one individual.

13. The method of claim 10, wherein the additional action event includes at least one selected from a group consisting of:
at least one manifestation meeting;
at least one functional behavior analysis; and
at least one behavior intervention plan.

14. The method of claim 8, further comprising:
if at least one triggering event has occurred, designating a status for at least one annual meeting.

15. The method of claim 14, wherein designating a status for at least one annual meeting further comprises:
identifying any previous meetings for at least one individual;
identifying any initial meetings for the at least one individual;
identifying any other triggering events for the at least one individual; and
identifying any relevant triggering events for the at least one individual.

16. The method of claim 15, wherein the triggering events are events that have created a future legal obligation to perform at least one additional action.

17. The method of claim 9, further comprising:
if at least one triggering event has occurred, designating a status for at least one reevaluation meeting.

18. The method of claim 17, wherein designating a status for at least one reevaluation meeting further comprises:
identifying any previous meetings for at least one individual;
identifying any initial meetings for the at least one individual;
identifying any other trigger events for the at least one individual; and
identifying any relevant trigger events for the at least one individual.

19. The method of claim 18, wherein the triggering events are events that have created a future legal obligation to perform at least one additional action.

20. The method of claim 10, further comprising:
if at least one triggering event has occurred, designating a status for at least one referral event.

21. The method of claim 20, wherein designating a status for at least one referral event further comprises:
identifying any previous referral events for at least one individual;
determining whether at least one eligibility meeting was due by the end of a current month for the at least one individual;
determining whether at least one eligibility meeting was held during the current month for the at least one individual; and
determining whether at least one eligibility meeting was held more than a specified time after any previous referral events for the at least one individual.

22. The method of claim 10, further comprising:
if the at least one triggering event occurred, designating a status for at least one individual education plan implementation.

23. The method of claim 22, wherein designating a status for at least one individual education plan implementation further comprises:
determining whether an individual education plan has an actual start date; and
determining whether the actual start date was before an individual education plan due date.

24. The method of claim 10, further comprising:
if a triggering event occurred, designating at least one reason for exiting a special education program.

25. The method of claim 10, further comprising:
if a triggering event occurred, designating a status for at least one assessment completion.

26. The method of claim 25, wherein designating a status for at least one assessment completion further comprises:
identifying at least one assessment completion due;
determining whether the assessment completion has an actual review date; and
determining whether the actual review date is before an assessment completion due date.

27. The method of claim 10, further comprising:
if a triggering event has occurred, determining a least restrictive environment for at least one individual.

28. The method of claim 10, further comprising:
if a triggering event has occurred, determining whether at least one student has left a special education program.

29. The method of claim 1, wherein the repository of data includes a plurality of event data, each of the plurality of event data having an associated date.

30. The method of claim 10, wherein determining whether a triggering event has occurred includes:
identifying event data from the plurality of data within a selected time period; and
determining whether each of the identified event data comprises a triggering event; and
setting at least one appropriate due date for future event obligations.

31. The method of claim 30, wherein the selected time period comprises at least one selected from a group consisting of:
a year; and
a month.

32. The method of claim 30, wherein identifying event data and determining whether each of the identified event data comprises a triggering event is repeated for a plurality of selected time periods.

33. The method of claim 8, wherein data related to the special education requirements is at least one selected from a group consisting of:
tenth suspension and related meeting data;
annual meeting status data;
reevaluation meeting status data;
referral processing status data;
gap analysis data;
individual education plan implementation delay data;
drop out and other exit reason data;
individual education plan assessment completion status data; and
least restrictive environment data.

34. The method of claim 33, wherein the annual meeting status data comprises at least one annual meeting delay reason selected from a group consisting of:
all reasons;
no reason specified;
not held;
parent requested delay;
provider late completing test;
school closed;
school scheduling error; and
waiting for ruling from an administrative law judge.

35. The method of claim 33, wherein the reevaluation meeting status data comprises at least one reevaluation meeting delay reason selected from a group consisting of:
all reasons;
no reason specified;
not held;
parent requested delay;
provider late completing test;
school closed;
school scheduling error; and
waiting for ruling from an administrative law judge.

36. The method of claim 33, wherein the referral processing status data comprises at least one referral delay reason selected from a group consisting of:
all reasons;
no reason specified;
not held;
parent requested delay;
provider late completing test;
school closed;
school scheduling error; and
waiting for ruling from administrative law judge.

37. The method of claim 33, wherein the service gap analysis data comprises at least one selected from a group consisting of:
expected sessions;
actual sessions; and
attempted sessions.

38. The method of claim 33, wherein the individual education plan implementation delay data comprises at least one delay reason selected from a group consisting of:
all reasons;
diligent efforts but no response from parents;
diligent efforts but parent failed to respond in a timely manner;
diligent efforts but parent and student whereabouts unknown;
due date too soon when student registered at school;
due date past when student registered at school;
failed to tell provider to start services;
lack of transportation;
late parent signature due to inadequate due diligence;
late parent signature due to initial refusal;
no parent surrogate available;
no reason specified;
non public placement transition;
not started;
parent permission refused;
parent requested delay until Head Start begins;
parent requested delay until new school year;
parent withdrew permission;
provider did not give assigned services;
student hospitalized;
student in treatment center;
student incarcerated;
student refused service;
TEP in effect during delay;
trouble assigning provider;
waiting for an administrative law judge ruling;
was not told student registered at school; and
weather delayed services.

39. The method of claim 33, wherein the individual education plan assessment completion status data comprises at least one delay reason selected from a group consisting of:
all delay reasons;
delay in assigning parent surrogate;
delayed because parent requested outside agency assessment;
delayed by need for supervisor's approval;
diligent efforts but no response from parent;
diligent efforts but parent failed to respond in timely manner;
diligent efforts but parent and student whereabouts unknown;
failed to tell provider to test student;
late parent signature but inadequate due diligence;
late parent signature but initial refusal;
no reason specified;
not completed;
parent failed to bring student for testing;
parent permission refused;
parent requested rescheduling of individual education plan review meeting;
prior school failed to do testing;
provider did not complete on time;
provider didn't file test on time;
provider not available in student's language;
student hospitalized;
student in treatment center;
student incarcerated;
student refuses to take test;
student requested break in testing session;
student unavailable for testing;
student under medical care;
supplemental aids not immediately available;
trouble assigning provider;
waiting for administrative law judge ruling;
was not told student had registered at school; and
weather delayed testing.

40. The method of claim 8, wherein data related to the special education requirements is at least one selected from a group consisting:
all disability data;
autism data;
deaf data;
deaf-blindness data;
developmental delay data;
emotional disturbance data;
hearing impaired data;
mental retardation data;
multiple disability data;
orthopedic impairment data;
health impairment data;
specific learning disability data;
speech impaired data;
language impaired data;
student in need of assessment data;
traumatic brain injury data; and
visual impairment data.

41. A computer program product comprising a computer usable medium having control logic stored therein for causing a computer to analyze data relating to a mandated program, the control logic comprising:
first computer readable program means for receiving a query;
second computer readable program means for accessing a repository of data relating to the mandated program; and
third computer readable program means for identifying data responsive to the query.

42. A computerized system for analyzing data relating to a mandated program, comprising:
a network;
at least one terminal coupled to the network;
at least one server coupled to the network; and
wherein the at least one server comprises a program that receives a query; accesses a repository of data relating to the mandated program; and identified data responsive to the query.
